(19) United States
(12) Patent Application Publication
(10) Pub. No.: US 2012/0274951 A1
(43) Pub. Date: Nov. 1, 2012

(54) INKJET PRINTING APPARATUS AND INKJET PRINTING METHOD

(75) Inventors: Hitoshi Nishikori, Inagi-shi (JP); Norihiro Kawatoko, Yokohama-shi (JP); Osamu Iwasaki, Tokyo (JP); Tomoki Yamamuro, Kawasaki-shi (JP); Atsuhiko Masuyama, Yokohama-shi (JP); Fumiko Suzuki, Kawasaki-shi (JP); Satoshi Masuda, Yokohama-shi (JP)

(73) Assignee: CANON KABUSHIKI KAISHA, Tokyo (JP)

(21) Appl. No.: 13/445,320

(22) Filed: Apr. 12, 2012

(30) Foreign Application Priority Data
Apr. 28, 2011 (JP) 2011-101236

(51) Int. Cl. G06K 15/02

(52) U.S. Cl. 358/1.2

(57) ABSTRACT

A large and small dot distribution pattern is generated, for each chip, according to a large and small dot distribution ratio and ejection failure nozzle information. In doing so, a bias of large and small dot distribution ratio at a nozzle position including an ejection failure nozzle is set to be smaller than that at a nozzle position that does not including an ejection failure nozzle. Then, dot data to be printed by the ejection failure nozzle is equally distributed to large dot nozzles that can eject normally and small dot nozzles. By such a configuration, even if a plurality of printing chips have different printing characteristics, ejection failure compensation processing is performed to minimize image degradation caused by an unexpected ejection failure and an average ejection volume of each of the chips converge on a fixed target ejection volume, which leads to reduction of density unevenness among the chips.

### BACKGROUND OF THE INVENTION

1. Field of the Invention

The present invention relates to an inkjet printing apparatus that uses a plurality of chips, each of the chips having a plurality of nozzles arranged to eject ink, to print an image. Specifically, the present invention relates to ejection failure compensation processing performed when an ejection failure occurs in a nozzle on a chip while correcting variations of a printing characteristic among a plurality of chips

2. Description of the Related Art

In an inkjet printing apparatus using a long print head, the print head is often configured by attaching a plurality of chips together. In such a print head, an ejecting characteristic such as an ejection volume varies depending on each chip, and this variation of an ejecting characteristic may cause density unevenness of an image.

U.S. Pat. No. 7,249,815 discloses an art to dispose a nozzle array for ejecting large dots and a nozzle array for ejecting small dots on each chip and to adjust an ejection ratio of large dots and small dots for each chip in order to correct such variation of an ejecting characteristic among chips. In such a configuration to adjust a ratio of printing of large dots and small dots, for showing the same density by using a plurality of chips having variation of an ejecting characteristic, the number of dots ejected by each chip is fixed. Therefore, compared with a conventional head shading technique to adjust the number of dots thereby to correct density unevenness, density unevenness can be reduced without provoking unnaturalness of an image caused by difference of the number of dots.

However, the present inventors have found out that in the case where a plurality of nozzles include an ejection failure nozzle and ejection failure compensation processing is performed in which another nozzle compensates data of this ejection failure nozzle, if the disclosure of U.S. Pat. No. 7,249,815 is employed, a new problem occurs.

According to U.S. Pat. No. 7,249,815, for example, in a chip whose density is relatively low, a rate to use large dots is set to be higher than a rate to use small dots. In such a chip, if nozzles for ejecting large dots include an ejection failure nozzle, interpolated data is printed by another nozzle for ejecting a large dot that can perform printing on the same position as a printing position of the ejection failure nozzle, as an alternative nozzle, in a common ejection failure compensation processing. As a result, the alternative nozzle ejects ink on the basis of both of ejection data of the alternative nozzle and ejection data of the ejection failure nozzle. In such a case, if an unexpected ejection failure occurs in the alternative nozzle, an image to be printed by the alternative nozzle, that is, both an image based on ejection data of the alternative nozzle and an image based on ejection data of the ejection failure nozzle are not printed. As a result, lack of a large volume of data may cause a harmful effect such as a streak on an image.

Generally, in an inkjet print head, an unexpected ejection failure may occur due to foreign matters or foams in a nozzle while the inkjet print head is used. Such an unexpected ejection failure often returns to normal ejection by continuing printing or performing recovery processing. However, even such an unexpected ejection failure causes an image to be lack of pixels to be printed. Therefore, in many inkjet printing apparatuses, printing of one line is equally divided to a plurality of nozzles so as to make lack of pixels less apparent.

However, in the case where, employing the disclosure of U.S. Pat. No. 7,249,815, a chip in which a rate to use large dots and a rate to use small dots are unequal is used, if bias of use of the nozzles is further increased due to ejection failure compensation processing, a risk is higher when an unexpected ejection failure occurs, compared with a conventional art.

### SUMMARY OF THE INVENTION

The present invention has been made to solve the above problems. Therefore, the object of the present invention is to provide an inkjet printing apparatus that is configured to perform ejection failure compensation processing while correcting density variation among chips with the use of large dots and small dots, thereby minimizing lack of pixels to be printed even if an unexpected ejection failure occurs.

In a first aspect of the present invention, there is provided an inkjet printing apparatus to print an image with the use of a print head, the print head provided with a plurality of chips, each of the chips comprising: a plurality of large dot nozzle arrays composed of nozzles to print large dots on a printing medium, the nozzles being arranged in a predetermined direction, the plurality of large dot nozzle arrays being arranged in a direction intersecting with the predetermined direction; and a plurality of small dot nozzle arrays composed of nozzles to print small dots on a printing medium, the nozzles being arranged in the predetermined direction, the plurality of small dot nozzle arrays being arranged in a direction intersecting with the predetermined direction, the plurality of chips being arranged along the predetermined direction in such a way that the nozzle are arranged in series in the predetermined direction, the inkjet printing apparatus comprising: an ejecting characteristic acquisition unit configured to acquire, for each of the chips, large dot ejecting characteristic information that indicates an ejecting characteristic of the large dot nozzle arrays, small dot ejecting characteristic information that indicates an ejecting characteristic of the small dot nozzle arrays and information about an ejection failure nozzle whose ejection state is not sufficient; a distribution ratio deciding unit configured to decide a large and small dot distribution ratio that specifies, for each of the chips, a printing ratio of large dots and small dots so that a density of an image to be printed on a printing medium is uniform among the plurality of chips, on the basis of the large dot ejecting characteristic information and the small dot ejecting characteristic information; and a generation unit configured to generate dot data corresponding to a plurality of normal ejection nozzles, of the plurality of large dot nozzle arrays and plurality of small dot nozzle arrays, that can print on the same position of a printing medium as a printing position of the ejection failure nozzle, on the basis of dot data of the ejection failure nozzle and the information acquired by the ejecting characteristic acquisition unit; wherein the distribution ratio deciding unit decides the large and small dot distribution ratio so that a bias of the large and small dot distribution ratio of dot data to be printed by a plurality of nozzles that can print on the same position of a printing medium as a printing position of the ejection failure nozzle is smaller than a bias of the large and small dot distribution ratio of dot data to be printed by a plurality of nozzles that can print on a position of a printing medium other than the printing position of the ejection failure nozzle.

In a second aspect of the present invention, there is provided an inkjet printing method to print an image with the use of a print head, the print head provided with a plurality of chips, each of the chips comprising: a plurality of large dot nozzle arrays composed of nozzles to print large dots on a printing medium, the nozzles being arranged in a predetermined direction, the plurality of large dot nozzle arrays being arranged in a direction intersecting with the predetermined direction; and a plurality of small dot nozzle arrays composed of nozzles to print small dots on a printing medium, the nozzles being arranged in the predetermined direction, the plurality of small dot nozzle arrays being arranged in a direction intersecting with the predetermined direction, the plurality of chips being arranged along the predetermined direction in such a way that the nozzle arrays are arranged in series in the predetermined direction, the method comprising: an ejecting characteristic acquisition step to acquire, for each of the chips, large dot ejecting characteristic information that indicates an ejecting characteristic of the large dot nozzle arrays, small dot ejecting characteristic information that indicates an ejecting characteristic of the small dot nozzle arrays and information about an ejection failure nozzle whose ejection state is not sufficient; a distribution ratio deciding step to decide a large and small dot distribution ratio that specifies, for each of the chips, a printing ratio of large dots and small dots so that a density of an image to be printed on a printing medium is uniform among the plurality of chips, on the basis of the large dot ejecting characteristic information and the small dot ejecting characteristic information; and a generation step to generate dot data corresponding to a plurality of normal ejection nozzles, of the plurality of large dot nozzle arrays and plurality of small dot nozzle arrays, that can print on the same position of a printing medium as a printing position of the ejection failure nozzle, on the basis of dot data of the ejection failure nozzle and the information acquired by the ejecting characteristic acquisition step; wherein the distribution ratio deciding step decides the large and small dot distribution ratio so that a bias of the large and small dot distribution ratio of dot data to be printed by a plurality of nozzles that can print on the same position of a printing medium as a printing position of the ejection failure nozzle is smaller than a bias of the large and small dot distribution ratio of dot data to be printed by a plurality of nozzles that can print on a position of a printing medium other than a printing position of the ejection failure nozzle.

Further features of the present invention will become apparent from the following description of exemplary embodiments (with reference to the attached drawings).

### BRIEF DESCRIPTION OF THE DRAWINGS

FIG. 1 is a diagram showing the relationship of FIGS. 1A and 1B;

FIG. 1A is a block diagram illustrating a configuration of image processing according to a first embodiment;

FIG. 1B is a block diagram illustrating a configuration of image processing according to a first embodiment;

FIG. 2 is a diagram illustrating a schematic configuration of a printing apparatus that can be used in the present invention;

FIGS. 3A and 3B are a detailed configuration of a print head;

FIGS. 4A and 4B are flow charts of processing process performed by a CPU according to the first embodiment;

FIGS. 5A and 5B are diagrams for describing multivalued error diffusion processing;

FIG. 6 is a pattern diagram for describing arrangement of dots for each level;

FIG. 7 is a pattern diagram for specifically describing conversion of inputted image data;

FIG. 8 illustrates decided dot arrangement patterns and corresponding large and small dot distribution patterns thereof;

FIGS. 9A to 9D illustrate distribution patterns that are generated by a large and small dot distribution pattern generating unit A40 according to various distribution ratios of large and small dots;

FIGS. 10A and 10B are diagrams showing the number of necessary dots, the number of placed dots and the number of shortage of dots;

FIG. 11 is a flow chart for describing a process to generate a large and small dot distribution pattern;

FIG. 12 is a schematic diagram for describing, in a stepwise fashion, generation of a large and small dot distribution pattern;

FIG. 13 is a diagram showing distribution ratios of large and small dots to be decided corresponding to a position of each nozzle;

FIG. 14 is a diagram showing large and small dot distribution ratios, as well as printing rates of large and small dot nozzle arrays with or without performing ejection failure compensation processing;

FIG. 15 is a diagram showing distribution ratios of large and small dots to be decided corresponding to each nozzle position;

FIG. 16 illustrates dot arrangement patterns and corresponding large and small dot distribution patterns thereof;

FIG. 17 is a pattern diagram for describing conversion of inputted image data;

FIG. 18 is a diagram showing large and small dot distribution ratios, as well as printing rates of large and small ink nozzle arrays with or without performing ejection failure compensation processing;

FIG. 19 is a diagram for describing the number of ejection failure nozzles and corresponding ranges of large and small dot distribution ratios thereof; and

FIGS. 20A and 20B are detailed configurations of another embodiment.

### DESCRIPTION OF THE EMBODIMENTS

### Summary of Line Printer

Hereinafter, an embodiment of the present invention will be described in detail.

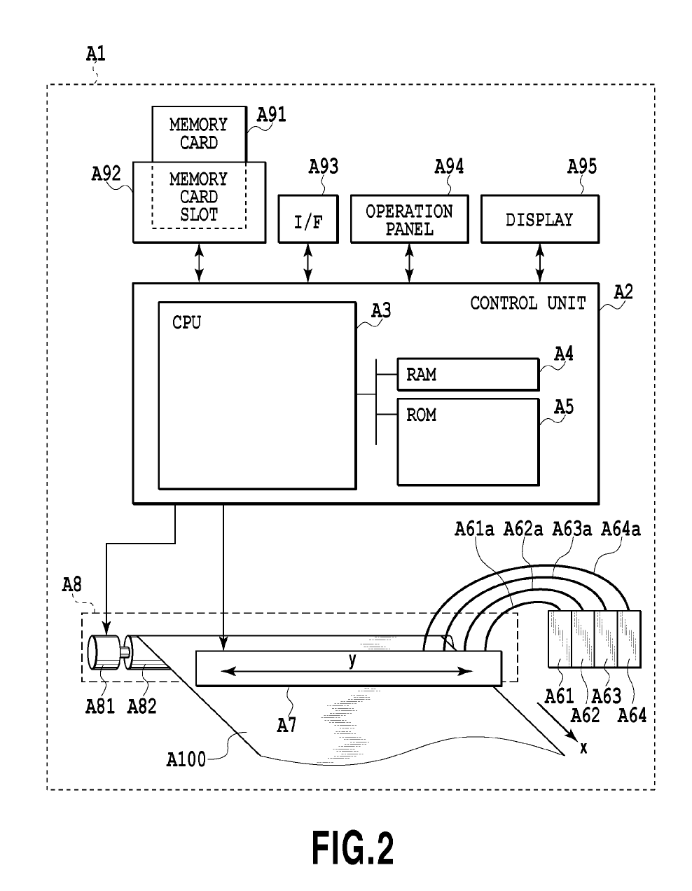

FIG. 2 is a diagram illustrating a schematic configuration of a printing apparatus A1 that can be used in an embodiment of the present invention. The printing apparatus A1 is a line inkjet printer and includes a control unit A2, ink cartridges A61 to A64, a print head A7 and a printing medium conveying mechanism A8.

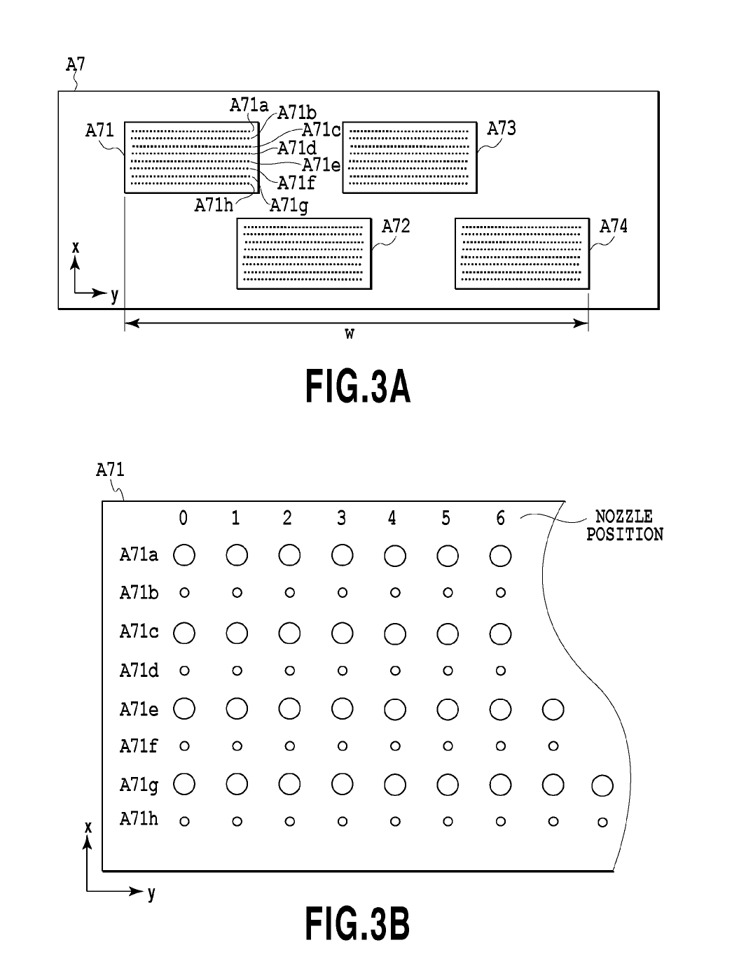

The print head A7 is a full-line type print head and includes a plurality of nozzles of thermal type that are arranged in parallel along y direction intersecting with a conveying direction (x direction) on a plane facing a printing medium and. The ink cartridges A61 to A64 accommodate cyan, magenta, yellow and black inks, respectively, which are supplied through ink introducing tubes A61a to A64a to the respective nozzles of the print head A7. Then, these nozzles eject ink according to image data, thereby performing printing on a printing medium A100 that is being conveyed in x direction at a constant speed. Details of the print head A7 will be described later with reference to FIGS. 3A and 3B.

The printing medium conveying mechanism A8 includes a paper conveying motor A81 and a paper conveying roller A82. The paper conveying motor A81 rotates the paper conveying roller A82 thereby to convey the printing medium A100 in x direction relative to the print head A7 at a constant speed.

The control unit A2 is composed mainly of a CPU A3, a RAM A4 and a ROM A5, processes received image data, and controls the print head A7 and a paper conveying roller A81 to perform printing operation. The CPU A3 executes a control program stored in the ROM A5 on the RAM A4 thereby to perform various image processing that will be described later. Then, the CPU A3 generates image data that can be printed by the print head A7, and controls the print head A7 and printing medium conveying mechanism A8 thereby to print an image on the printing medium.

FIGS. 3A and 3B are a detailed configuration of the print head A7. As illustrated in FIG. 3A, on the print head A7 according to the present embodiment, a plurality of chips A71 to A74, each having a plurality of nozzle arrays arranged, are arranged in such a way that the chips are staggered in x direction and aligned in y direction. Each nozzle of such a print head ejects ink on a printing medium that is being conveyed in x direction thereby to print an image matching a print head width w.

FIG. 3B illustrates an arrangement of nozzle arrays on one chip A71. On one chip A71, eight of nozzle arrays from A71a to A71h are arranged, each of the nozzle arrays being composed of a plurality of nozzles arranged in a predetermined pitch (1200 dpi in the present embodiment) in a predetermined direction (y direction, here). Nozzle arrays A71a, A71c, A71e and A71g are large dot nozzle arrays that eject a larger volume of ink droplets (a first volume of ink droplets) thereby to print large dots on a printing medium. Meanwhile, nozzle arrays A71b, A71d, A71f and A71h are small dot nozzle arrays that eject a smaller volume of ink droplets (a second volume of ink droplets that is less than the first volume) thereby to print small dots on a printing medium. Eight nozzles at the same position included in these eight nozzle arrays (eight nozzles aligned vertically in FIG. 3B) perform printing on the same column of the printing medium that is being conveyed.

### First Embodiment

Hereinafter, image processing according to a first embodiment in the inkjet printing apparatus will be described. First, in the present embodiment, a printing characteristic is an ink volume (hereinafter also referred to as an ejection volume) that is ejected from each chip A71 to A74 disposed on the print head A7. As an example, the case in which it has been previously found out that a nozzle at a nozzle position 2 of a small dot nozzle array A71f and a nozzle at a nozzle position 2 of a small dot nozzle array A71h have an ejection failure and these nozzles are subjected to ejection failure compensation processing will be described.

### <Summary of Image Processing Unit>

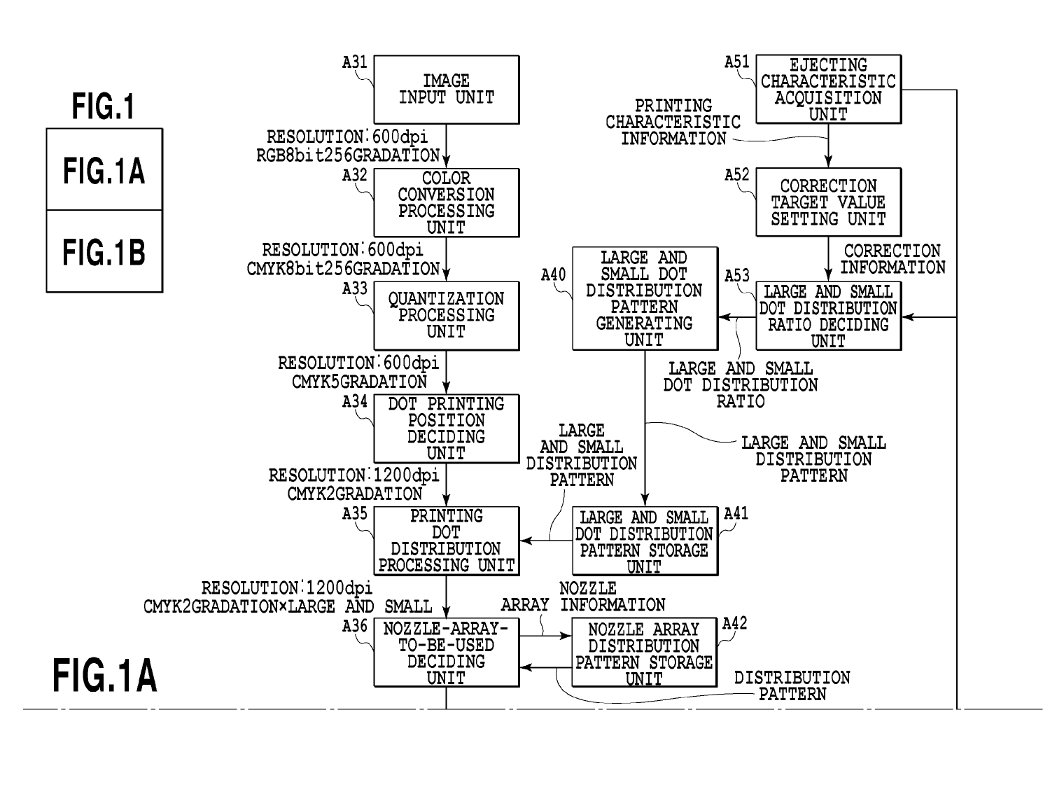

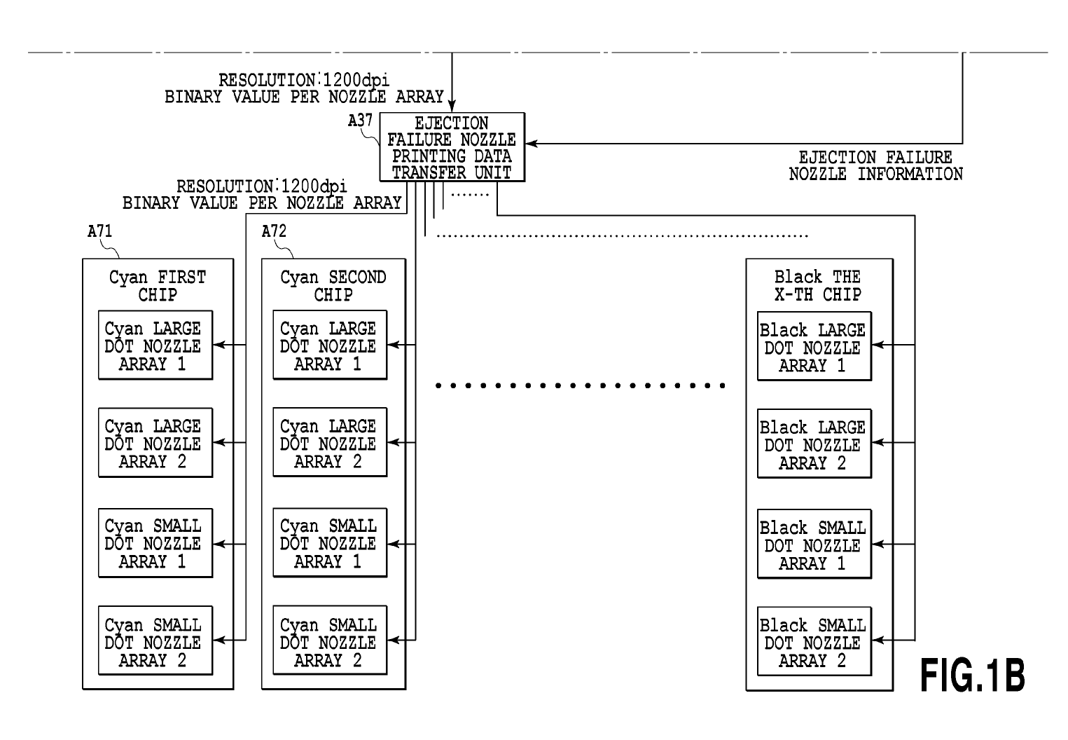

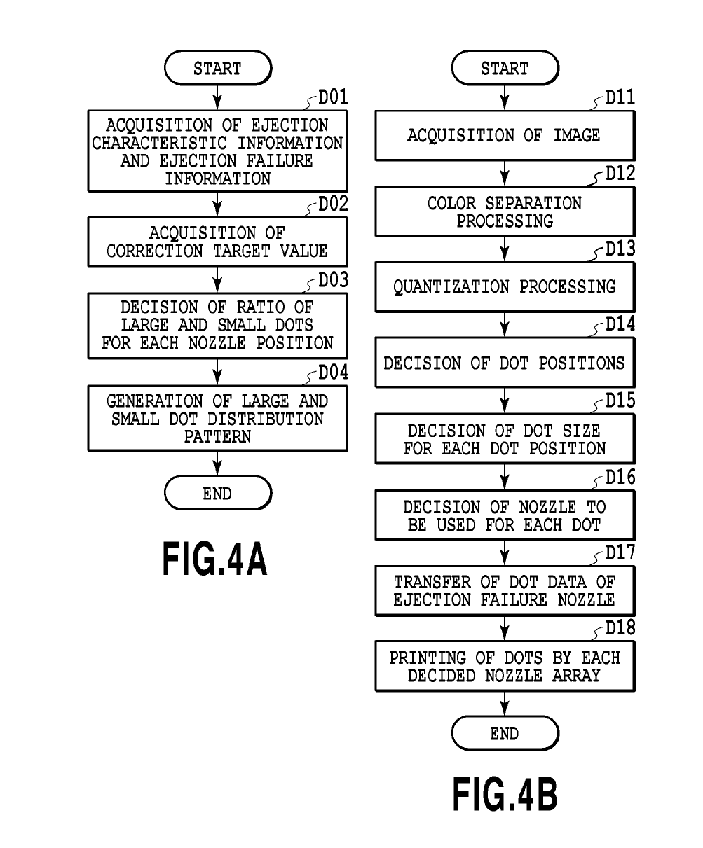

FIGS. 1A and 1B are a block diagrams illustrating a configuration of image processing according to the present embodiment. Each of blocks A31 to A53 in FIG. 1A indicates each of functions that a control section A2 of the printing apparatus A1 in FIG. 2 has. FIGS. 4A and 4B are flow charts for describing processing performed by the CPU A3 of the present embodiment, referring to the block diagram in FIGS. 1A and 1B.

FIG. 4A is a flow chart illustrating a process in which the CPU A3 sets printing rates of large dots and small dots of each of chips A71 to A74 in order to correct density unevenness. The process of FIG. 4A is performed prior to actual image printing. Meanwhile, FIG. 4B is a flow chart of image processing performed by the CPU A3 during actual image printing.

First, FIG. 4A will be described with reference to FIG. 1. At Step D01, the CPU A3 uses an ejecting characteristic acquisition unit A51 to acquire average ejection volume information (large dot ejecting characteristic information and small dot ejecting characteristic information) and ejection failure nozzle information of each of eight nozzle arrays arranged on chips A71 to A74. Such information may be determined and stored in a ROM or the like at shipping of the printing apparatus and may be read out by the ejecting characteristic acquisition unit A51. Or, an image reading device such as a scanner and an area sensor may be provided to read a pattern actually printed by each nozzle array, and then the ejecting characteristic acquisition unit A51 may detect an ejection volume and whether there is an ejection failure nozzle and a position of the ejection failure nozzle. Here, suppose that, in chip A71, an average ejection volume of large dot nozzle arrays A71a, A71c, A71e and A71g is 3 ng, and an average ejection volume of small dot nozzle arrays A71b, A71d, A71f and A71h is 2 ng. The ejection failure nozzle information indicates a position on the chip of a nozzle whose ejection is not sufficient, and such ejection failure nozzle information is also sent to a large and small dot distribution ratio deciding unit A53 and an ejection failure nozzle printing data transfer means A37, which will be described later.

At a subsequent Step D02, the CPU A3 uses a correction target value setting unit A52 to set a target ejection volume for each of the chips A71 to A74. The target ejection volume is an ideal ejection volume that is required for each of the chips in common in order to obtain a standard image density. In the present embodiment, a target ejection volume for each chip is set to be 2.25 ng.

At Step D03, the large and small dot distribution ratio deciding unit A53 sets, for each chip and for each nozzle position, a ratio of pixels using large dots (a large dot distribution ratio) and a ratio of pixels using small dots (a small dot distribution ratio) of ink droplets that are ejected to print an image on a predetermined region, on the basis of the ejection volume information acquired at Step D01 and the target ejection volume set at Step D02. That is, a ratio of the number of pixels to be printed with large dots (3 ng) and the number of pixels to be printed with small dots (2 ng) is controlled thereby to make an average ejection volume for a whole chip 2.25 ng. In this example, a distribution ratio of large dots and small dots for each nozzle position is set to be 1:3. However, as a characteristic of the present embodiment, as for a nozzle corresponding to a nozzle position that is decided to be an ejection failure in the ejection failure nozzle information acquired at Step D01, a distribution ratio of large dots and small dots is uniformly set to be 1:1, without depending on ejection volume information.

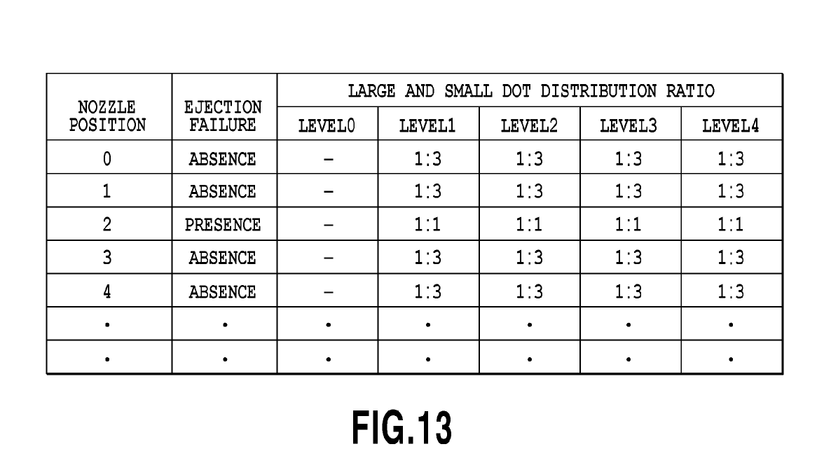

FIG. 13 is a diagram showing distribution ratios of large and small dots that the large and small dot distribution ratio deciding unit A53 decides for each nozzle position, in this example. For nozzle positions (0, 1, 3, 4 . . . ) whose nozzles perform normal ejection, a distribution ratio is set to be 1:3 for all levels. For nozzle position 2 that includes an ejection failure nozzle, a distribution ratio is set to be 1:1 for all levels.

Returning to FIG. 4B, at Step D04, the large and small dot distribution pattern generating unit A40 generates large and small dot distribution patterns on the basis of the distribution ratios decided at Step D03 to decide printing positions of large dots and printing position of small dots. These distribution patterns are provided according to each of quantized values of level 0 to level 4 that will be described later and according to a distribution ratio of each of the chips A71 to A74. The generated large and small dot distribution patterns are stored in a large and small dot distribution pattern storage unit A41. Details of these large and small dot distribution patterns and a method of generating thereof will be described later.

Once a large and small dot distribution pattern is set for each nozzle position according to ejection volume information and ejection failure information as described above, this processing is completed.

Next, with reference to FIGS. 1A and 1B, an image processing process at the time of image printing in FIG. 4B will be described. Once a printing command is inputted, the CPU A3 uses an image input unit A31 to read image data from a memory card A91 and to store the read image data in the RAM A4 (Step D11). This embodiment uses a color image data whose resolution is 600 dpi (dots per inch) and each pixel is represented by eight bits (256 gradations) for each of RGB. It should be appreciated that this is only an example, and the image processing process can also be applied to a monochrome image.

At Step D12, the CPU A3 uses a color conversion processing unit A32 to perform color conversion processing on image data. Color conversion processing converts luminance data of RGB (red, green blue) that each pixel has to density data of CMYK (cyan, magenta, yellow, black) corresponding to ink colors to be used by a printing apparatus. This converts 8-bit RGB data of 600 dpi to 8-bit CMYK data of 600 dpi.

At a subsequent Step D13, the CPU A3 uses a quantization processing unit A33 to perform quantization processing on CMYK data that has been subjected to color conversion. This quantization processing converts 8-bit CMYK data represented by 256 values to CMYK data represented by less level value (five values, here). As the quantization processing, multivalued error diffusion processing is employed here although a dither method can be employed.

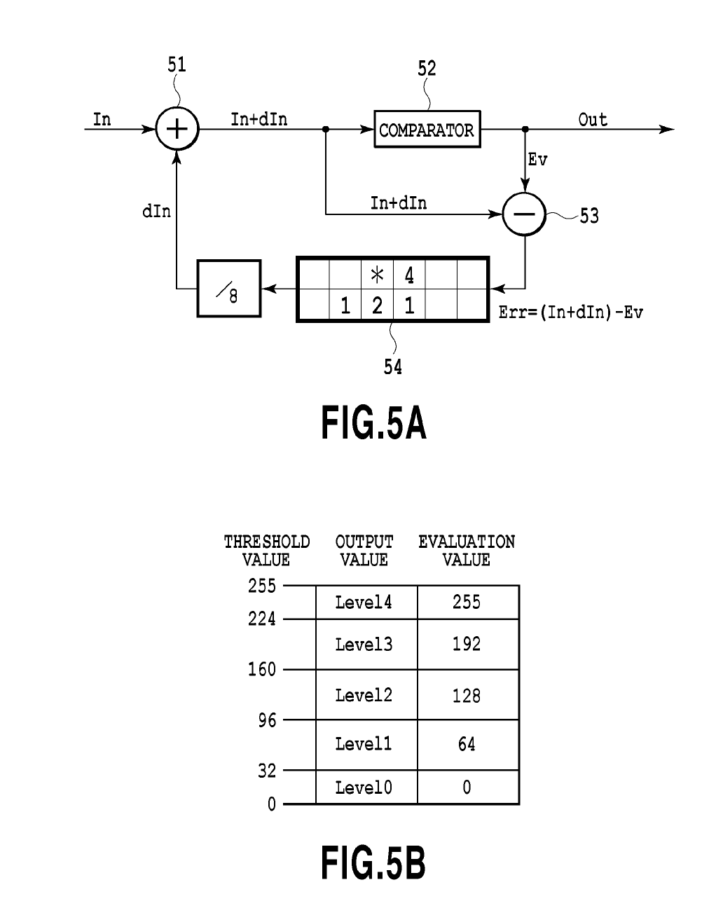

FIGS. 5A and 5B are diagrams for describing multivalued error diffusion processing according to the present embodiment. In FIGS. 5A and 5B, an adder 51 adds an accumulated error (dIn) that occurred from peripheral pixels to an input signal (In) that is 8-bit density data to obtain a value (In+dIn), and after that a comparator 52 compares the obtained value (In+dIn) with a plurality of threshold values that are preliminarily provided. FIG. 5B is a diagram showing a relationship between the plurality of threshold values used for comparison by the comparator, output values (Out) obtained as a result of comparison, and evaluation values.

The comparator 52 quantizes an input value (In+dIn) to five values from Level 0 to Level 4, according to the input value. For example, in the case where an input value (In+dIn)<32, a quantized value is Level 0. In the case of 96>(In+dIn)>32, a quantized value is Level 1. In this way, according to a comparison of levels between an input value (In+dIn) and four threshold values (32, 96, 160, 224), the comparator 52 outputs any of quantized values from level 0 to level 4 as an output value (Out). In doing so, the comparator 52 outputs evaluation values Ev (0, 64, 128, 192, 255) corresponding to the quantized values, respectively to a subtractor 53.

To the subtractor 53, an evaluation value Ev from the comparator 52 and an added value (In+dIn) from the adder 51 are inputted. The subtractor 53 calculates a difference between these values, that is, Err=(In+dIn)−Ev, that is an error occurs in quantization. Further, in order to distribute this error to peripheral pixels, a predetermined weighting calculation is performed, and the calculated result is added to an error buffer 54 that is provided corresponding to peripheral pixels. FIG. 5A illustrates one example of a weighting coefficient used when an error that occurred at a position of a pixel of interest (*) is distributed to peripheral pixels in the error buffer 54. In a region corresponding to each pixel in the error buffer, every time a pixel of interest is changed, a new error value is added. Then, when a new pixel of interest is quantized, an accumulated error at corresponding pixel position is read out from the error buffer 54 and normalized by using summation of weighting coefficients, and the normalized accumulate error is sent as an accumulated error dIn to the adder 51.

As described above, in multivalued error diffusion processing employed in the present embodiment, by distributing an error that occurs in each pixel to peripheral pixels, density data represented by 256 gradations for each pixel is converted to density data represented by five values.

Returning to FIG. 4B, once quantization processing D13 is completed, the CPU A3 inputs a quantized value of 600 dpi and five values to a dot printing position deciding unit A34 to decide a dot arrangement within a pixel of interest. As a result, a quantized value of 600 dpi and five values is converted to binary data of 1200 dpi.

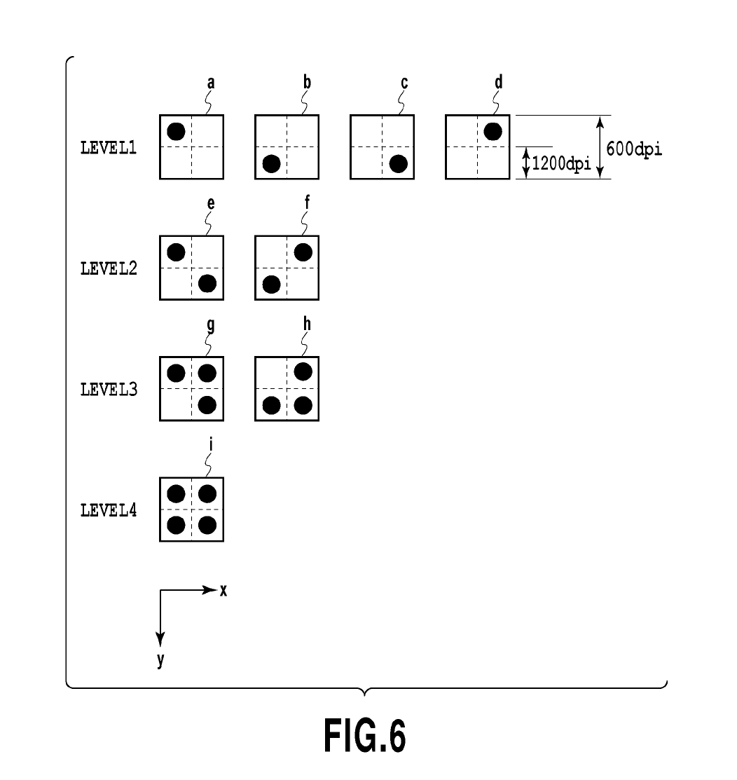

FIG. 6 is a diagram for describing dot arrangement corresponding to each level. One pixel region of 600 dpi corresponds to a region of 2 pixels×2 pixels of 1200 dpi, values of 0 to 4 are converted to binary data of 1200 dpi indicating printing of a dot (1) or not-printing of a dot (0).

For example, if a quantized value is level 1, a dot is placed in only one pixel of 2×2 pixels. In this case, four arrangement patterns “a” to “d” can be provided. With respect to level 2 and level 3, two arrangement patterns can be provided; and with respect to level 4, one arrangement pattern can be provided. In the present embodiment, a plurality of patterns corresponding to the same level value are repeated in order in x direction in order.

Returning to FIG. 4B, at a subsequent Step D15, the CPU A3 uses a dot distribution processing unit A35 to distribute dots that have been set to be printing (1) in a dot arrangement pattern to large dots and small dots. Specifically, large and small dot distribution patterns previously stored in the large and small dot distribution pattern storage unit A41 are read out, and according to the read-out patterns, the dot arrangement pattern decided by the dot printing position deciding unit A34 is distributed to dot data for large dots and dot data for small dots.

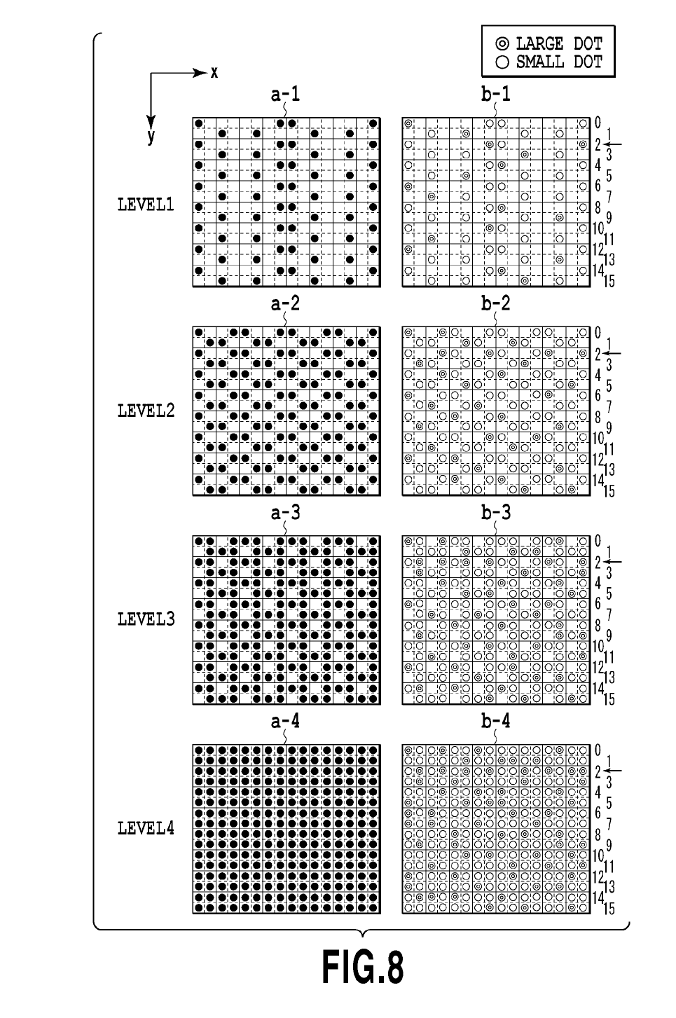

FIG. 8 illustrates dot arrangement patterns decided by the dot printing position deciding unit A34 and large and small dot distribution patterns corresponding thereto. (a-1) to (a-4) are dot arrangement patterns corresponding to level 1 to level 4 outputted from the dot printing position deciding unit A34, respectively. FIG. 8 illustrates patterns in which pixels of 600 dpi having the same level are arranged in 8×8 in x direction and y direction for each level. For example, in a dot pattern (a-1) corresponding to level 1 shows that “a” to “d” patterns corresponding level 1 of FIG. 6 are arranged in order in x direction.

Meanwhile, (b-1) to (b-4) shows one example of distribution patterns of level 1 to level 4 that are generated by the large and small dot distribution pattern generating unit A40 in the case where a distribution ratio of large and small dots is 1:3 and nozzles at nozzle position 2 of nozzle arrays A71f and A71h have an ejection failure. In FIG. 8, a position indicated by double circle is a pixel to print large dot, and a position indicated by single circle is a pixel to print a small dot. For each level, a position having a dot in the dot arrangement pattern is associated with either a large dot or a small dot. At all nozzle positions except the ejection failure nozzle position 2 indicated by an arrow, a ratio of the number of large dots and small dots of pixels to be printed is 1:3. With respect to pixels to be printed (pixels at one horizontal row in FIG. 8) at the ejection failure nozzle position 2 indicated by the arrow, since the large and small dot distribution ratio deciding unit A53 has set the distribution ratio to be 1:1, a ratio of the number of large dots and small dots of pixels to be printed at the nozzle position 2 is 1:1 at any of (b-1) to (b-4). In this way, the large and small dot distribution pattern generating unit A40 generates, on the basis of a distribution ratio of each nozzle position that is decided by the large and small dot distribution ratio deciding unit A53, large and small dot distribution patterns corresponding to level 1 to level 4, to store them in a large and small dot distribution storage unit A41.

The printing dot distribution processing unit A35 reads out a dot pattern at a corresponding pixel position in a corresponding level value thereby to generate data for large dots and data for small dots for each pixel.

With reference to FIG. 8, a case where a distribution ratio is uniformly 1:3 has been described, a distribution ratio of large and small dots that is decided by the large and small dot distribution ratio deciding unit A53 can be set for each nozzle position on each chip, as illustrated in FIG. 13. Therefore, the large and small dot distribution pattern generating unit A40 provides, for a plurality of chips, a distribution pattern whose distribution ratio is adjusted at each nozzle position according to the distribution ratio decided by the large and small dot distribution ratio deciding unit A53.

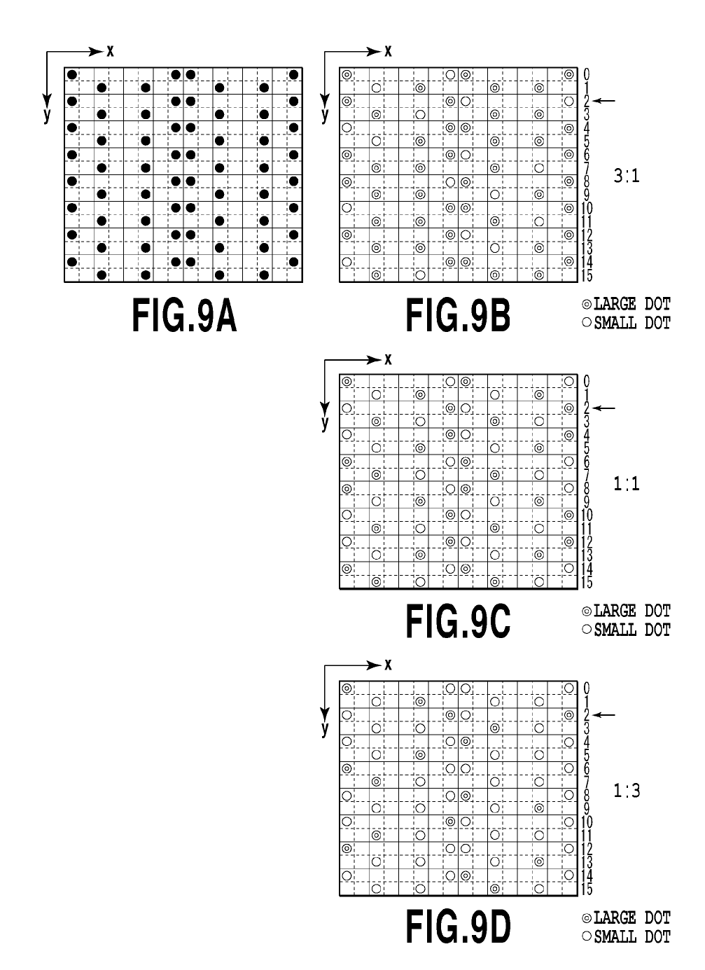

FIGS. 9A to 9D illustrate distribution patterns that are generated by the large and small dot distribution pattern generating unit A40 according to various distribution ratios of large and small dots. FIG. 9A illustrates a dot arrangement pattern corresponding to level 1 that is outputted from the dot printing position deciding unit A34 and corresponds to an upper left portion of (a-1) in FIG. 8. FIGS. 9B to 9D illustrate large and small dot distribution patterns that are generated by the large and small dot distribution pattern generating unit A40, corresponding to a region of FIG. 9A. FIG. 9B illustrates a distribution pattern for level 1 in which a distribution ratio of large and small dots is 3:1 and nozzles at nozzle position 2 of nozzle arrays A71f and A71h has an ejection failure. Similarly, FIG. 9C illustrates a distribution pattern for level 1 in which a distribution ratio of large and small dots is 1:1 and FIG. 9D illustrates a distribution pattern for level 1 in which a distribution ratio of large and small dots is 1:3. In any of FIGS. 9B to 9D, a ratio of the number of large dots and small dots at each nozzle position is decided according to a corresponding distribution ratio. Since the large and small dot distribution ratio deciding unit A53 sets a distribution ratio to 1:1 for nozzle position 2, a ratio of the number of large dots and small dots of pixels where a dot is printed at nozzle position 2 is 1:1 in any of FIGS. 9B to 9D. Although an example in which nozzles at nozzle position 2 include an ejection failure nozzle has been described here, it should be appreciated that in the case where nozzles at a position other than position 2 include an ejection failure nozzle, a distribution ratio at the nozzle position is set to be 1:1 and a large and small dot distribution pattern according to the ratio is generated. Then, the printing dot distribution processing unit A35 reads a dot pattern of a corresponding distribution ratio, a corresponding level value, and a corresponding pixel position of a large and small dot distribution pattern thereby to generate large dot data and small dot data for each pixel.

Returning to FIG. 4B, at Step D16, the CPU A3 uses a nozzle-array-to-be-used deciding unit A36 to distribute each of large dot data and small dot data to a plurality of nozzle arrays on a chip. Specifically, a mask pattern that is previously stored in a nozzle array distribution pattern unit A72 is read out, and AND processing is performed between the mask pattern and large dot data or small dot data that is decided by the printing dot distribution processing unit A35. As a result, a dot pattern to be printed by each nozzle array is decided. Details of the mask pattern will be described later.

At a subsequent Step D17, the CPU A3 uses an ejection failure nozzle printing data transfer unit A37 to transfer dot data corresponding to an ejection failure nozzle to a nozzle that can perform printing on the same position of a printing medium as a printing position of an ejection failure nozzle. That is, dot data corresponding to an ejection failure nozzle is transferred to a plurality of nozzles at the same nozzle position. In doing so, data is transferred so that data is distributed as equally as possible to a plurality of nozzles that are at the same position as a position of an ejection failure nozzle and can perform a normal ejection. Since a method to transfer printing data for ejection failure compensation processing is well known, the method will not be described in detail.

At Step D18, each nozzle ejects ink according to printing data set to each nozzle array to thereby print an image. That is, the CPU A3 drives the paper conveying motor A81 and make the print head A7 to eject ink on the basis of printing data for each nozzle array in synchronization with the movement caused by the paper conveying motor A81. As a result, printing is performed so that a ratio of the number of large dots and the number of small dots is 1:3, thereby an image appropriate to a density of a target ejection volume 2.25 ng can be outputted without a defect caused by an ejection failure being apparent.

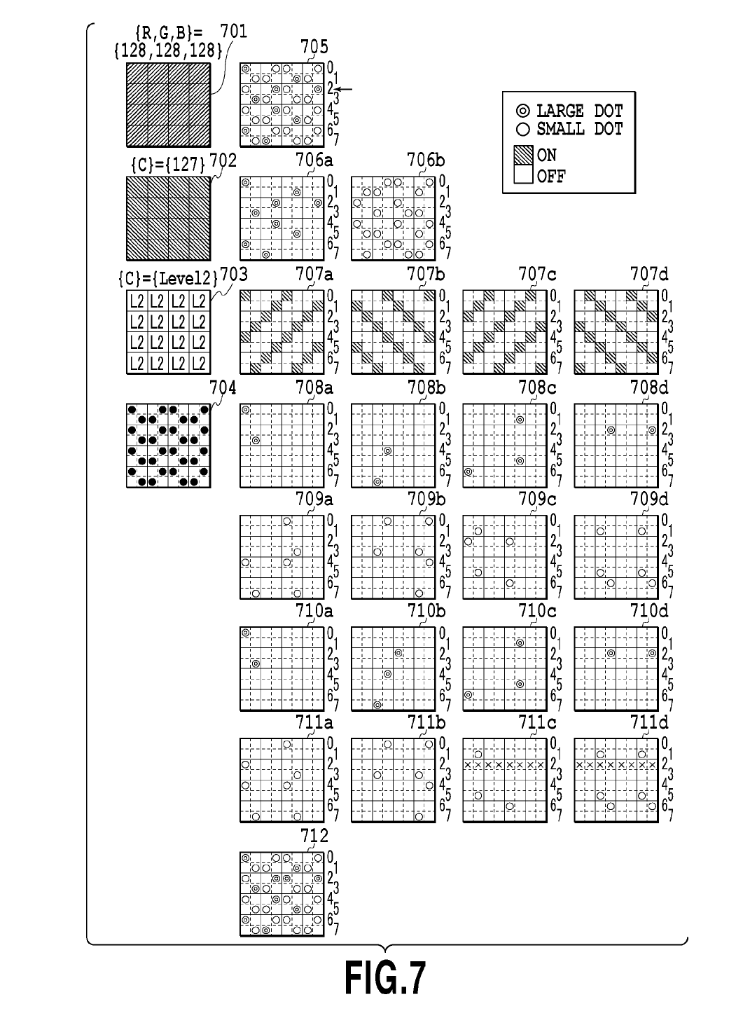

FIG. 7 is a pattern diagram for specifically describing conversion of a predetermined inputted image data in the respective processes described above.

701 is inputted image data received by the image input unit A31 and illustrates 4×4 pixel regions of 600 dpi corresponding to nozzle position 0 to nozzle position 7. In this example, each pixel has data of (R, G, B)=(128, 128, 128). 702 illustrates multivalued data of cyan after data of each pixel of the image region is subjected to color conversion by color conversion processing unit A32. Here, a signal value of the cyan multivalued data is C=127. 703 illustrates a result of quantization of the multivalued data 702 by the quantization processing unit A33 according to a multivalued error diffusion method described in FIGS. 5A and 5B. Here, all of the pixels are quantized to level 2. 704 illustrates a dot pattern that is converted from a quantized value 703 by a dot printing position setting unit A34 on the basis of a dot pattern described in FIG. 6.

705 is a large and small dot distribution pattern generated by the large and small dot distribution pattern generating unit A40. Also in 705, pixels corresponding to nozzle position 2 that includes an ejection failure nozzle (pixels in a horizontal row in FIG. 7) is indicated by an arrow. In pixels corresponding to nozzle positions other than nozzle position 2, a ratio of the number of large dots (double circle) and the number of small dots (single circle) is 1:3 whereas in pixels corresponding to nozzle position 2, the ratio is 1:1. The printing dot distribution processing unit A35 distributes a dot pattern 704 on the basis of this large and small dot distribution pattern 705 thereby to obtain large dot data 706a and small dot data 706b.

707a to 707d are mask patterns for distributing large dot data 706a to any of large dot nozzle arrays and small dot data 706b to any of small dot nozzle arrays. These mask patterns are previously stored in a nozzle array distribution pattern storage unit A42. Specifically, 707a is a mask pattern to decide pixels that can be printed by a large nozzle array A71a and a small nozzle array A71b. 707b is a mask pattern to decide pixels that can be printed by a large nozzle array A71c and a small nozzle array A71d. 707c is a mask pattern to decide pixels that can be printed by a large nozzle array A71e and a small nozzle array A71f. 707d is a mask pattern to decide pixels that can be printed by a large nozzle array A71g and a small nozzle array A71h. In each of the mask patterns, pixels indicated by shadow (ON) are pixels that permit printing of dots of a corresponding nozzle array, and pixels indicated by white (OFF) are pixels that do not permit printing of dots. Each of these four mask patterns has a print-permitting rate of 25%, and these masks have a complementally relationship to one another among them.

The nozzle-array-to-be-used deciding unit A36 reads out such mask patterns that are previously stored in the nozzle array distribution pattern unit A72, and performs AND processing between the read-out mask patterns and large nozzle dot data or small nozzle dot data that is decided by the printing dot distribution processing unit A35. As a result, the large dot data 706a is distributed to dot data 708a for a nozzle array A71a, dot data 708b for a nozzle array A71c, dot data 708c for a nozzle array A71e and dot data 708d for a nozzle array A71g. Meanwhile, the small dot data 706b is distributed to dot data 709a for a nozzle array A71b, dot data 709b for a nozzle array A71d, dot data 709c for a nozzle array A71f and dot data 709d for a nozzle array A71h. That is, the whole large dot data 706a is printed by A71a, A71c, A71e and A71g and the whole of small dot data 706b is printed by A71b, A71d, A71f and A71h.

Although in this example the same mask patterns are used for large dots and small dots, different mask patterns may be used for large dots and small dots as long as four mask patterns for large dots have a complementally relationship to one another and four mask patterns for small dots have a complementally relationship to one another.

710a to 710d illustrate dot data of large dot nozzle arrays A71a, A71c, A71e, and A71g after the ejection failure nozzle printing data transfer means A37 transfers printing data of an ejection failure nozzle to other nozzles at the same position as a nozzle position of the ejection failure nozzle. Similarly, 711a to 711d illustrate dot data of small dot nozzle arrays A71b, A71d, A71f and A71h after transfer.

In this example, the ejecting characteristic acquisition unit A51 has found out that nozzles at nozzle position 2 in small dot nozzle arrays A71f and A71h have an ejection failure. Therefore, the ejection failure nozzle printing data transfer means A37 transfers dot data corresponding to nozzle position 2 (data corresponding to pixels at the third line from the top) of dot data 709c for a small dot nozzle array A71f and dot data 709d for a small dot nozzle array A71h, to other nozzle arrays. In this example, two dot data corresponding to nozzle position 2 in a small dot nozzle array A71f is transferred to a large dot nozzle array A71c and a small dot nozzle array A71b. Meanwhile, since there is no dot data corresponding to nozzle position 2 in the small dot nozzle array A71h, data is not transferred. The above processing converts data 708a to 708d of four large dot nozzle arrays to dot data 710a to 710d and converts data 709a to 709d of four small dot nozzle arrays to dot data 711a to 711d.

712 illustrates distribution of large dots and small dots to be actually printed according to the dot data. In this image region, a distribution ratio of large and small dots is virtually 1:3, and a density appropriate to a target ejection volume 2.25 ng can be realized. As for nozzle position 2 including an ejection failure nozzle, an ejection volume is locally larger than the target ejection volume 2.25 ng, but is not increased to an ejection volume that makes density difference among chips apparent, thereby an image can be outputted without a defect caused by an ejection failure being apparent.

A case where ejection failure compensation processing is performed so as to make an average ejection volume of a chip A71 approach a target ejection volume has been described. However, such image processing is performed similarly and independently for other chips. Hereinafter, in a chip A72 in which an average ejection volume of large dot nozzle arrays is 2.5 ng and an average ejection volume of small dot nozzle arrays is 1.5 ng, processing in which a target ejection volume is set to 2.25 ng, as with the chip A71, will be briefly described.

In such balance of ejection volumes, the large and small dot distribution ratio deciding unit A53 decides a distribution ratio of large dots and small dots to be 3:1. Then, the large and small dot distribution pattern generating unit A40 generates a large and small dot distribution pattern on the basis of the distribution ratio and ejection failure information of the chip A72. If there is an ejection failure nozzle at the same position as that of the chip A71, a large and small dot distribution pattern for level 1, for example, becomes a pattern in FIG. 9B, which was already described. A large and small dot distribution pattern generated in this way is stored in the large and small dot distribution pattern storage unit A41, and is read out by the printing dot distribution processing unit A35 when image processing of the chip A72 is performed. Processing after that is the same as processing described with respect to the chip A71.

As described above, in the present embodiment, large and small dot distribution patterns are generated for each chip according to a large and small dot distribution ratio and ejection failure nozzle information. In doing so, a large and small dot distribution ratio at a nozzle position including an ejection failure nozzle is set to be uniformly 1:1, thereby preventing a usage rage of large dots and a usage rate of small dots from being biased. On that basis, dot data to be printed by the ejection failure nozzle is equally distributed to large dot nozzles that can perform normal ejection and small dot nozzles that can perform normal ejection. Such a configuration, even if a plurality of chips have different printing characteristics, allows for ejection failure compensation processing to minimize image degradation caused by an unexpected ejection failure, thereby approaching an average ejection volume of each chip to a fixed target ejection volume and reducing density unevenness among chips.

### <Method to Generate Large and Small Dot Distribution Pattern>

Hereinafter, one example of a process to generate large and small dot distribution patterns that is performed by the large and small dot distribution pattern generating unit A40 according to the present embodiment will be described.

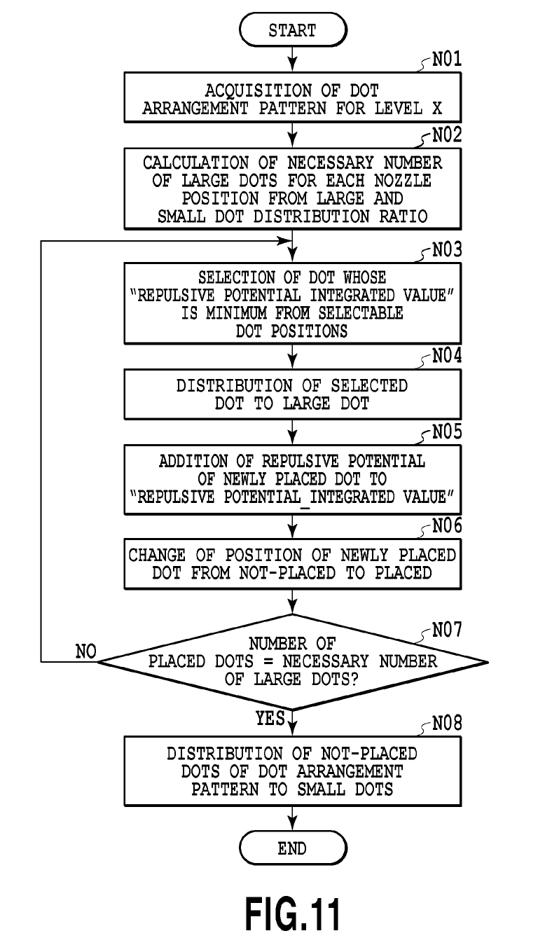

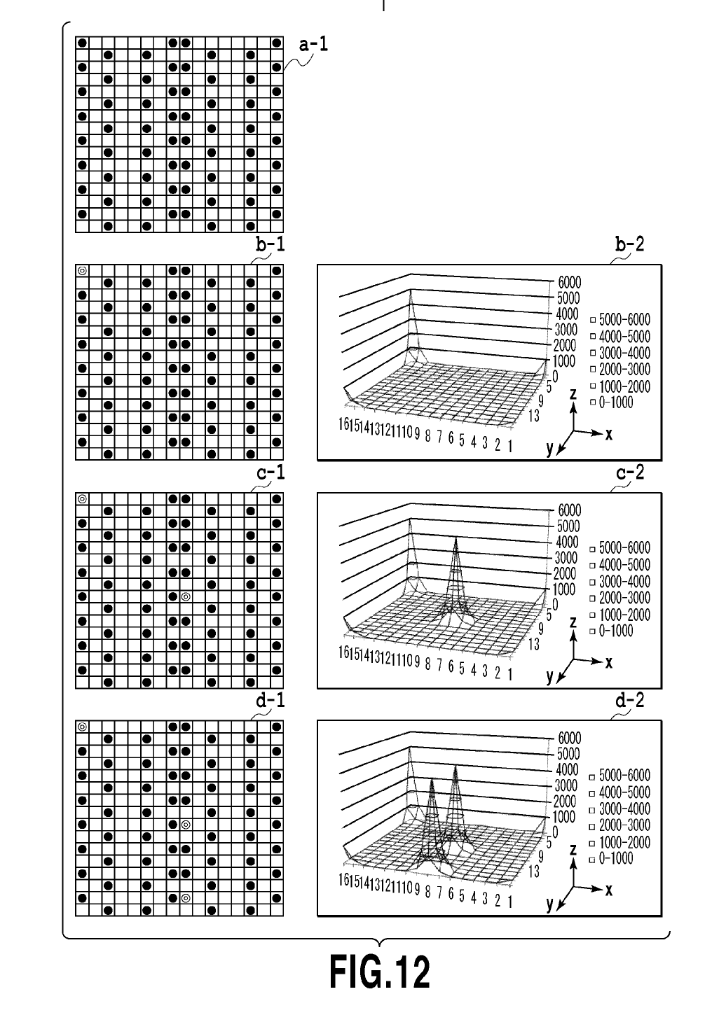

FIG. 11 is a flow chart for describing a process to generate large and small dot distribution patterns that is performed by the large and small dot distribution pattern generating unit A40. FIG. 12 is a schematic diagram for describing, in a stepwise fashion, generation of large and small dot distribution patterns in the case of a quantization level 1. In the present embodiment, a repulsive potential is used in order to place large dots at a spatial frequency that is as constant as possible and in a highly distributed state.

First, at Step N01 in FIG. 11, a dot pattern of a quantization level for which large and small dot distribution patterns will be generated is acquired. Here, a case of level 1 will be described as an example. Therefore, a dot pattern acquired at Step N01 is a-1 in FIG. 12.

At Step N02, from a distribution ratio set by the large and small dot distribution ratio deciding unit A53 and the a dot pattern a-1, the number of large dots and the number of small dots that are necessary in the dot pattern a-1 (the necessary number of large dots and the necessary number of small dots) are calculated for each nozzle position. Referring to the dot pattern a-1, in this example, the number of dots to be printed by nozzles at each nozzle position is 4, and a distribution ratio set by the large and small dot distribution ratio deciding unit A53 is 1:3. Therefore, the number of large dots to be printed at each nozzle position (the necessary number of large dots) is 1, and the number of small dots to be printed at each nozzle position (the necessary number of small dots) is 3. However, at nozzle position 2 including an ejection failure nozzle, since a distribution ratio is 1:1, the necessary number of large dots is 2 and the necessary number of small dots is 2.

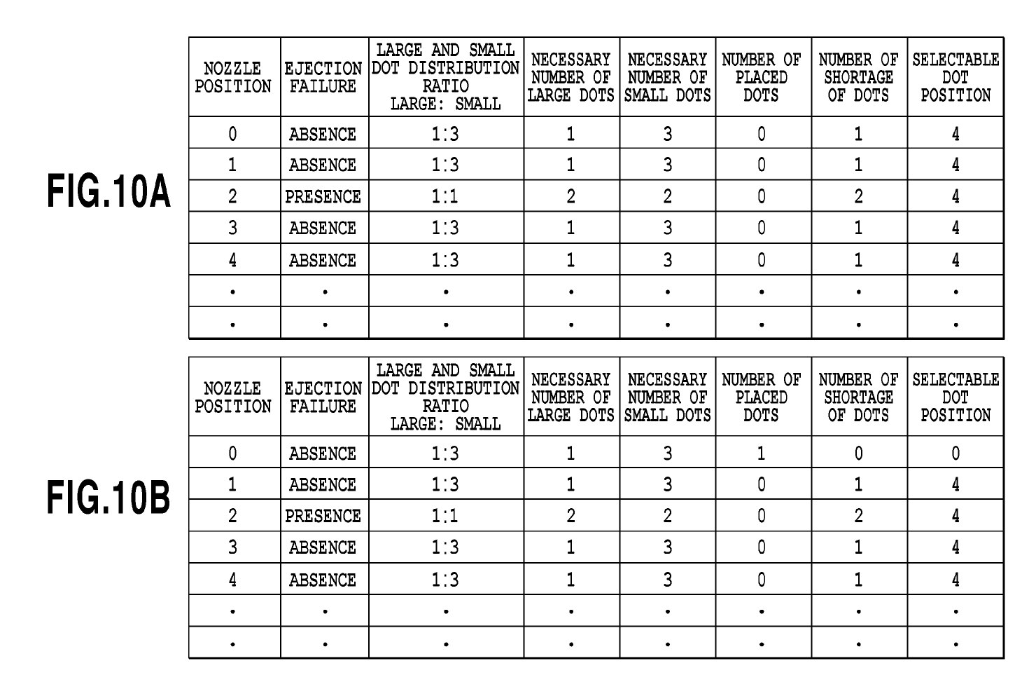

FIGS. 10A and 10B are diagram showing the necessary number of dots, the number of placed dots, the number of shortage of dots and the like for each nozzle position at each stage of generating large and small dot distribution patterns. FIG. 10A shows a stage after completion of Step N02. At the stage of Step N02, since any of dots to be placed in a dot pattern is not decided to be a large dot or a small dot, the number of placed large dots is 0. As a result, the number of dots that is short to the necessary number of large dots (the number of shortage of large dots) is 2 at nozzle position 2 and 1 at positions other than nozzle position 2, respectively. In placing large dots, the number of positions where a large dot can be placed (a selectable dot position) is four.

At Step N03, a position whose “repulsive potential_integrated value” is minimum is selected from selectable dot positions. In distributing the first dot, since “a repulsive potential_integrated value” is “0” at all positions, any dot position can be selected. In this example, suppose that a pixel at the upper left corner, that is, a dot of (X,Y)=(0,0) is selected.

At Step N04, the dot selected at Step N03 is distributed to a large dot. In FIG. 12, b-1 illustrates a state where a dot at the upper left in the dot pattern a-1 is converted to a large dot.

At Step N05, a repulsive potential of the distributed large dot is added to “a repulsive potential_integrated value”. Hereinafter, a repulsive potential will be described.

In the present embodiment, in order to set a repulsive potential having a sharp gradient with the placed large dot being at a center, an isotropic repulsive potential is used in which “50000” is at the center of the placed dot and “10000/(fourth power of a distance)” is at other positions. Here, suppose that “Pot_alone” shows a repulsive potential of a single dot, a potential of position (x, y) is as follows:

Pot_alone=50000 (x=0,y=0)

10000/(x̂2+ŷ2)̂2 (x≠0, y≠0) 1.

In order to satisfy a boundary condition, suppose that the same pattern continues rightward, lower-rightward, and downward, a repulsive potential Pot(x, y) at the position (x, y) is as follows:

Pot_{—}0(x,y)=Pot_alone(x,y)

+Pot_alone(x+array_{—}X,y) 1.

+Pot_alone(x−array_{—}X,y) 2.

+Pot_alone(x,y−array_{—}Y) 3.

+Pot_alone(x+array_{—}X,y−array_{—}Y) 4.

+Pot_alone(x−array_{—}X,y−array_{—}Y) 5.

+Pot_alone(x,y+array_{—}Y) 6.

+Pot_alone(x+array_{—}X,y+array_{—}Y) 7.

+Pot_alone(x−array_{—}X,y+array_{—}Y) 8.

array_X: the number of pixels in x direction of a dot pattern (16 in the present embodiment)

array_Y: the number of pixels in y direction of a dot pattern (16 in the present embodiment)

In the case where a large dot is placed at an arbitrary position (a, b), a repulsive potential of a position (x, y) can be obtained by substituting a relative position of the position (x, y) from the position (a, b) to the above Pot_0(x, y) as follows:

Pot_{—}ab(x,y)=Pot_{—}0(Pos_{—}x,Pos_{—}y)

Pos_{—}x=x−a (x≧a)

a−x (x≦a)

Pos_{—}y=y−b (y≧b)

b−y (y≦b)

In FIG. 12, b-2 illustrates a repulsive potential that occurs by placing a large dot as a value in z direction relative to x-y plane.

Returning to FIG. 11, at Step N06, various parameters described with reference to FIG. 10A are rewritten with placing a large dot at Step N04. That is, the number of placed large dots, the number of shortage of large dots and a selectable dot position are rewritten to 1, 0 and 0, respectively. FIG. 10B is a diagram after various parameters are rewritten at Step N06.

At a subsequent Step N07, it is determined whether the number of shortage of large dots is 0 or not at all nozzle positions. If it is not determined that the number of shortage of large dots is 0 at all nozzle positions, processing returns to Step N03 in order to place a subsequent large dot. Here, processing at Step N03 to place the second large dot will be described.

At Step N03, a position having a minimum “repulsive potential_integrated value” is selected from remaining selectable dot positions. If there are a plurality of dot positions whose “repulsive potential_integrated value” is a minimum value, one dot position is selected by generating a random number. Here, suppose that (x, y)=(8, 8) is selected, for example.

At a subsequent Step N04, the dot selected at Step N03 is distributed to a large dot. In FIG. 12, c-1 illustrates a state where a dot at position of (x, y)=(8, 8) is further converted to a large dot (double circle) from the dot pattern b-1. Further, at Step N05, a repulsive potential of the distributed large dot is added to a “repulsive potential_integrated value”. In FIG. 12, c-2 illustrates a state where a large dot is further placed at the position of (x, y)=(8, 8) in addition to a graph b-2 of a repulsive potential. Then, at Step N06, parameters are rewritten again.

Processes at Step N03 to N06 described above are repeated until it is determined that there is no shortage of dots at all nozzle positions. If it is determined that the number of shortage of dots is 0 at all nozzle positions, processing proceeds to Step N08 where all of remaining dots other than dots distributed to large dots are distributed to small dots. Then, this processing is completed.

By placing large dots with the use of a repulsive potential in this way, large dots can be placed with a virtually fixed spatial frequency, thereby increasing dispersibility of large dots. As a result, even if printing is performed by using a plurality of chips, each having a different distribution ratio of large and small dots, a difference of a pattern among chips is less apparent. Since a low frequency component, which tends to be visible relatively, of a spatial frequency of large dots is suppressed, a good result can be obtained regarding graininess and uniformity.

With reference to the flow chart in FIG. 8, a case where a quantized value is level 1 was described. In the case where a large and small dot distribution pattern corresponding to greater or equal to level 2 is generated, a distribution pattern generated at the next level below can be utilized without any change. In this case, at Step N01, a large and small dot distribution pattern at the next level below is obtained as a specified pattern and processing on and after Step N03 may be performed for remaining undistributed dots. This can reduce processing time in the large and small dot distribution pattern generating unit A40 and a continuity between levels is obtained thereby preventing an unintended agglomeration of large dots or small dots. In FIG. 8, (b-1) to (b-4) are large and small dot distribution patterns generated in this way.

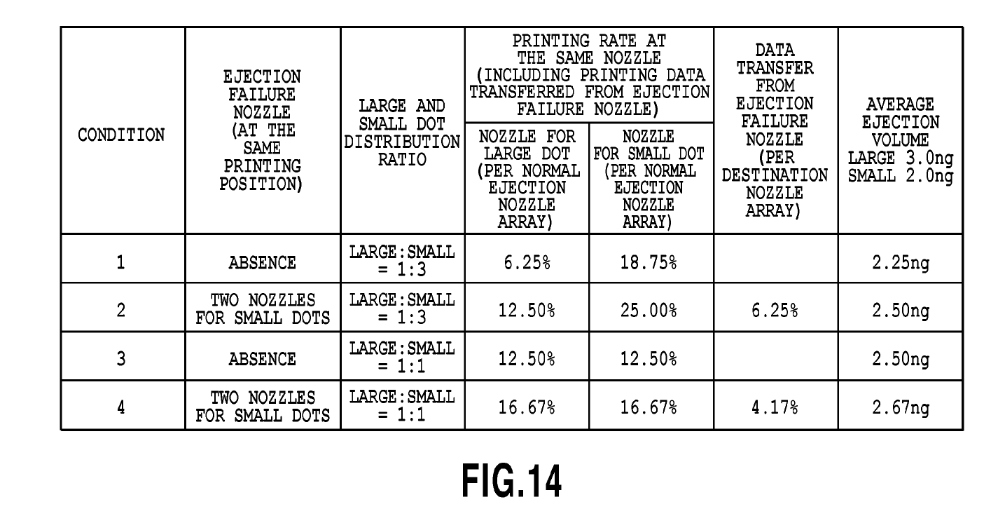

FIG. 14 is a diagram showing large and small dot distribution ratios and printing rates of large and small dot nozzle arrays with or without performing ejection failure compensation processing in the case where four arrays of large dot nozzle, each having an ejection volume of 3.0 ng, and four arrays of small dot nozzle, each having an ejection volume of 2.0 ng, are used for a target ejection volume of 2.25 ng.

In FIG. 14, Condition 1 shows a case where a distribution ratio of large and small dots is set to be 1:3 in order to realize a target ejection volume and there is no ejection failure nozzle. In this case, a printing rate per large dot nozzle array is 6.25% (=100×(1/(1+3))×(¼)) and a printing rate per small dot nozzle array is 18.75% (=100×(3/(1+3))×(¼)). An average ejection volume per chip is 2.25 (=3.0×(¼)+2.0×(¾)) that is equal to a target ejection volume.

Condition 2 shows a case where, a distribution ratio of large and small dots is the same as Condition 1, two small dot nozzles have an ejection failure and ejection failure compensation processing is performed. In this case, data of the two nozzles of four small dot nozzles are equally distributed to remaining four large dot nozzles and two small dot nozzles. That is, a printing rate of two small dot nozzle arrays is distributed to the six nozzles, increasing a printing rate of each of the nozzles by 6.25 (=18.75%× 2/6) %. As a result, a printing rate per large dot nozzle array becomes 12.5% (=6.25+6.25), and a printing rate per small dot nozzle array becomes 25% (=18.75+6.25). In the case where a printing rate per small dot nozzle array increases to 25%, if an unexpected ejection failure occurs at the small dot nozzle array, a concern that a white streak becomes apparent in an image is increased.

Meanwhile, Condition 3 shows a case where a distribution ratio of large and small dots is 1:1 and there is no ejection failure nozzle. In this case, both of a printing rate per large dot nozzle array and a printing rate per small dot nozzle array are 12.5% (=100×1/(4+4)). An average ejection volume per chip is 2.5 (=3.0×(½)+2.0×(½)). However, since the average ejection volume 2.5 ng is larger than a target ejection volume 2.25 ng, if a distribution ratio is set to be 1:1 at all nozzle positions, a density of a whole chip is increased, provoking density unevenness.

Condition 4 shows a case where a distribution ratio of large and small dots is the same as that of Condition 3, two small dot nozzles have an ejection failure and ejection failure compensation processing is performed. In this case, as with Condition 2, a printing rate of the two small dot nozzle arrays is distributed to the six nozzles, increasing a printing rate of each nozzle by 4.17% (=12.5× 2/6). As a result, both of a printing rate per large dot nozzle array and a printing rate per small dot nozzle array become 16.67% (=12.5+4.17). Comparing Condition 4 with Condition 2, since in Condition 4 printing rates does not have bias, even if an unexpected ejection failure occurs at one nozzle array, a risk that a white streak becomes apparent in an image is reduced.

In light of the above, in the present embodiment, at a nozzle position where ejection failure compensation processing is performed, a distribution ratio of large and small dots is set to be 1:1, giving a priority to preventing image degradation caused by an unexpected ejection failure. Meanwhile, at nozzle positions where ejection failure compensation processing is not performed, a distribution ratio of large and small dots is set to be 1:3, giving a priority to realizing a target ejection volume in order to suppress density unevenness among chips. By employing such a configuration, density variation among chips is corrected by a large number of nozzles at nozzle positions where an ejection failure does not occur and reliable ejection failure compensation processing is performed at a small number of nozzle positions where an ejection failure occurs, thereby preventing image degradation caused by an unexpected ejection failure. That is, according to the present embodiment, while, as with U.S. Pat. No. 7,249,815, density unevenness among chips is corrected, more reliable and less risky ejection failure compensation processing can be realized.

### Embodiment 2

In the first embodiment, at a nozzle position including an ejection failure nozzle, a distribution ratio of large and small dots is set to be 1:1 regardless of the number of ejection failure nozzles. Then, after each of dot data of large dots and small dots are distributed to each nozzle array with the use of four types of mask patterns, data of an ejection failure nozzle is transferred to other nozzles at the same positions.

Meanwhile, in the present embodiment, at a nozzle position including an ejection failure nozzle, according to the number (rate) of large dot nozzles and the number (rate) of small dot nozzles other than ejection failure nozzles, a distribution ratio of large dots and small dots is decided so as to make a printing rate of each of the nozzles equal. By utilizing ejection failure nozzle information acquired by the ejecting characteristic acquisition unit, a mask pattern that does not have a pixel permitting an ejection failure nozzle to print is used thereby to distribute data of large dots and data of small dots to nozzle arrays that can perform normal ejection. Hereinafter, specific processing according to the present embodiment will be described.

Also in the present embodiment, large and small dot distribution patterns are generated according to a flow chart in FIG. 4B. However, at Step D03 in the present embodiment, at nozzle positions including an ejection failure nozzle, a distribution ratio of large and small dots is not set to be uniformly 1:1. In the present embodiment, a distribution ratio of large and small dots is decided so as to make a printing rate among nozzles other than ejection failure nozzles, that is, nozzles that can perform normal ejection equal. Specifically, referring to FIG. 3B, if at nozzle position 2, two small dot nozzle arrays A71f and A71h have an ejection failure, large and small dots are distributed so that a printing rate of remaining nozzle arrays, that is, four large dot nozzle arrays and two small dot nozzle arrays is equal. That is, in this embodiment, since a ratio of the number of large dot nozzle arrays and the number of small dot nozzle arrays is 4:2, a distribution ratio is set to be 2:1 then a printing rate (= 2/4) of the large dot nozzle arrays and a printing rate (=½) of the small dot nozzle arrays can be equalized.

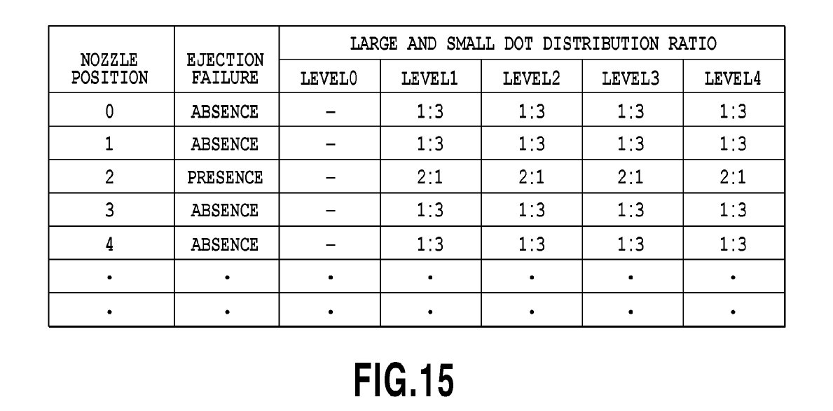

FIG. 15 is a diagram showing a distribution ratio of large and small dots that is decided by the large and small dot distribution ratio deciding unit A53 according to each nozzle position in this embodiment. At nozzle positions (0, 1, 3, 4 . . . ) where ejection is normal, a distribution ratio is decided to be 1:3 for all levels whereas at nozzle position 2 where there is an ejection failure, a distribution ratio is decided to be 2:1 for all levels.

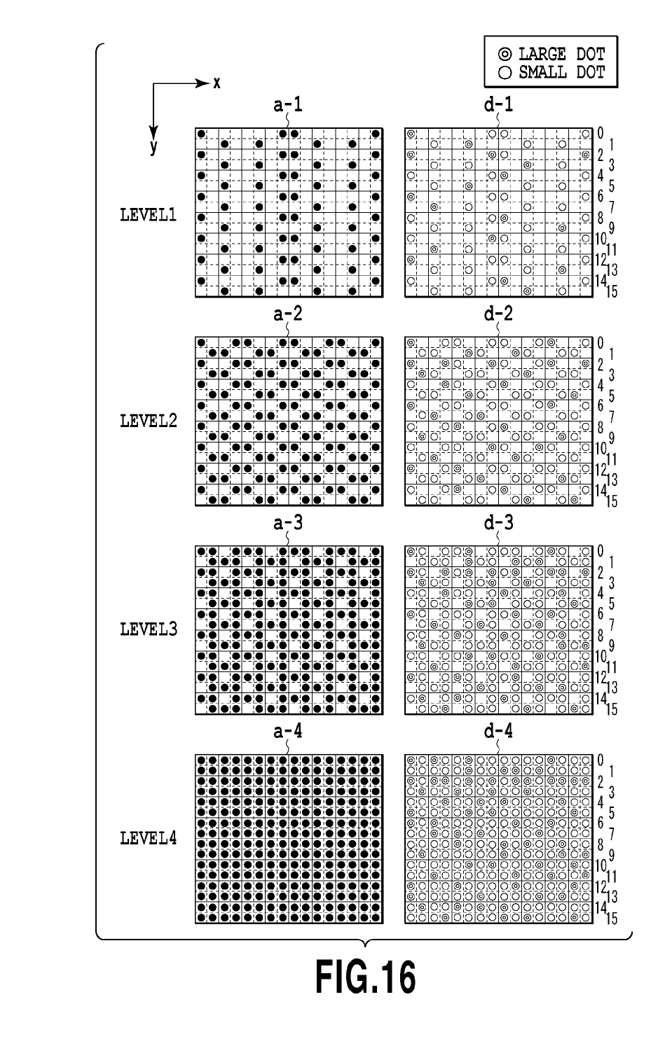

FIG. 16 illustrates dot arrangement patterns decided by the dot printing position deciding unit A34 and large and small dot distribution patterns corresponding thereto according to the present embodiment. In FIG. 16, a-1 to a-4 are dot arrangement patterns for level 1 to level 4 that are outputted from the dot printing position deciding unit A34, as with FIG. 8 a-1 to a-4 described in the first embodiment.

Meanwhile, d-1 to d-4 are one example of distribution patterns for level 1 to level 4 that are generated by the large and small dot distribution pattern generating unit A40 in the present embodiment. Also at nozzle positions other than an ejection failure nozzle position, a ratio of the number of large dots and the small dots is 1:3. At an ejection failure nozzle position 2, since a distribution ratio is set to be 2:1 by the large and small dot distribution ratio deciding unit A53, a ratio of the number of large dots and the number of small dots at the nozzle position 2 is 2:1 at any of d-1 to d-4.

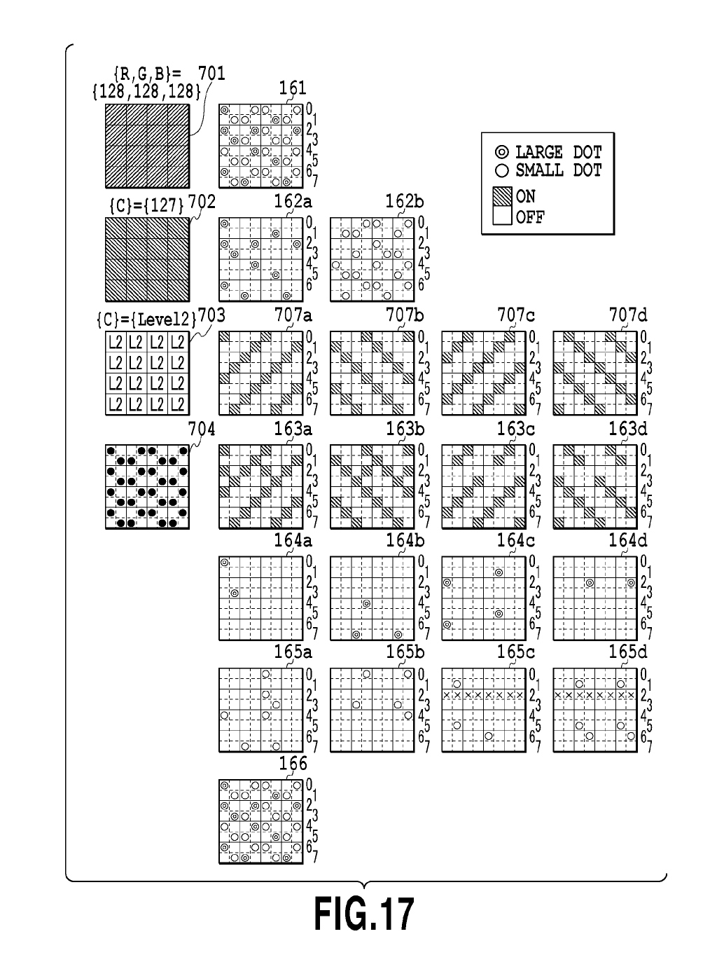

FIG. 17 is a pattern diagram for describing conversion of a predetermined inputted image data at each process of the present embodiment, comparing the present embodiment with the pattern diagram in FIG. 7. In FIG. 17, 701 to 704 are equivalent to 701 to 704 in FIG. 7 described in the first embodiment.

161 is a large and small dot distribution pattern generated by the large and small dot distribution pattern generating unit A40 according to the present embodiment. At nozzle positions other than nozzle position 2, a ratio of the number of large dots and the number of small dots is 1:3 whereas at nozzle position 2 the ratio is 2:1. The printing dot distribution processing unit A35 distributes a dot pattern 704, on the basis of the large and small dot distribution pattern 161, thereby to obtain large dot data 162a and small dot data 162b.

707a to 707d are mask patterns for distributing large dot data 706a and small dot data 706b to any of large dot nozzle arrays and any of small dot nozzle arrays, respectively, as with the first embodiment. However, in the present embodiment, these mask patterns 707a to 707d cannot be used for a combination having an ejection failure nozzle. That is, in this embodiment, the mask patterns 707a to 707d are used for large dot nozzle arrays (A71a, A71c, A71e, A71h), but are not used for small dot nozzle arrays (A71b, A71d, A71f, A71g).

Meanwhile, 163a to 163d are mask patterns that are used for a combination having an ejection failure nozzle (four small dot nozzle arrays in the present embodiment). These four mask patterns have a complementally relationship to one another, but mask patterns 163c and 163d corresponding to two nozzle arrays (A71f, A71h) having an ejection failure nozzle do not have a pixel permitting to print at nozzle position 2. In mask patterns 161c and 162d corresponding to two nozzle arrays (A71b, A71d) that do not have an ejection failure nozzle, pixels permitting to print at nozzle position 2 are more than those at other nozzle positions. In this way, in the present embodiment, ejection failure compensation processing can be performed with the use of dots having the same size as the size of a dot of an ejection failure nozzle. The present embodiment also provides a means to generate such a mask pattern according to ejection failure information.

After that, AND processing is performed between the mask patterns (707a to 707d) and large nozzle dot data 162a thereby to obtain dot data (164a, 164b, 164c, 164d) of the large dot nozzle arrays (A71a, A71c, A71e, A71g), and AND processing is performed between the mask patterns (163a to 163d) and small nozzle dot data 162b thereby to obtain dot data (165a, 165b, 165c, 165d) of the small dot nozzle arrays (A71b, A71d, A71f, A71h).

166 illustrates distribution of large dots and small dots that are actually printed according to the dot data. In this image region, a distribution ratio of large and small dots is virtually 1:3 and a density commensurate with a target ejection volume 2.25 ng can be realized. At nozzle position 2 including an ejection failure nozzle, an ejection volume is locally larger than a target ejection volume 2.25 ng, but an image can be outputted without a defect caused by an ejection failure being apparent.

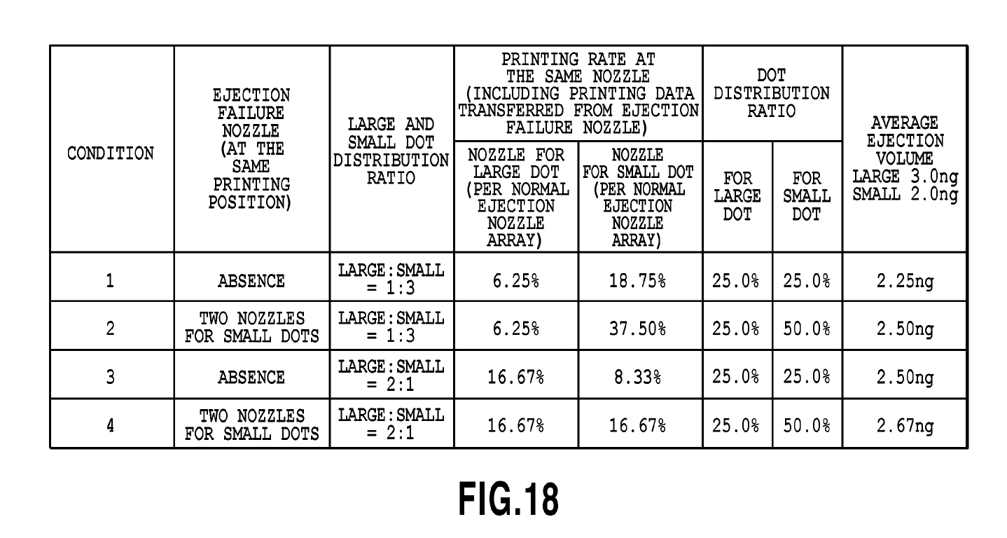

FIG. 18 is a diagram showing printing rates of large and small dot nozzle arrays according to large and small dot distribution ratios and with or without ejection failure compensation processing being performed in the present embodiment, as with FIG. 14 for the first embodiment. In FIG. 18, Condition 1 is the same as Condition 1 in FIG. 14.

Condition 2 shows a case where a ratio of large and small dots is the same as that of Condition 1, an ejection failure occurs in two small dot nozzles, and ejection failure compensation processing according to the present embodiment is performed, that is, data (print permitting pixels) of small dot nozzle arrays is transferred to data (print permitting pixels) of other two small dot nozzle arrays. In this case, a printing rate of the two small dot nozzle arrays is distributed other two small nozzles and therefore a printing rate of these two small dot nozzle arrays is doubled. As a result, a printing rate per large dot nozzle array remains 6.25%, but a printing rate per small dot nozzle array becomes 37.5% (=18.75×2). In this way, since a printing rate per small dot nozzle array is higher than that in the first embodiment, if an unexpected ejection failure occurs in the small dot nozzle array, a white streak becomes apparent in an image.

Meanwhile, Condition 3 shows a case where a distribution ratio of large and small dots is 2:1, and there is no ejection failure nozzle. In this case, a printing rate per large dot nozzle array is 16.67% (=100×2/(2+1)×¼) and a printing rate per small dot nozzle array is 8.33% (=100×1/(2+1)×¼).

Condition 4 shows a case where a distribution ratio of large and small dots is the same as that of Condition 3, an ejection failure occurs in two small dot nozzles, and ejection failure compensation processing of the present embodiment is performed, that is, data (print permitting pixels) of two small dot nozzle arrays are transferred to data (print permitting pixels) of other two small dot nozzle arrays. Also in this case, as with Condition 2, a printing rate of the two small dot nozzle arrays is distributed to the other two small dot nozzles, thereby doubling a printing rate of these small dot nozzle arrays. As a result, a printing rate per large dot nozzle array remains 16.67% and a printing rate per small dot nozzle array also becomes 16.67% (=8.33×2). Comparing Condition 4 with Condition 2, since printing rates are not biased in Condition 4, even if an unexpected ejection failure occurs in one nozzle array, a risk to make a white streak in an image apparent is reduced.

In light of the above, in the present embodiment, data of an ejection failure nozzle is transferred to a normal-ejection nozzle that has the same size of ejection volume as that of the ejection failure nozzle, and also at the nozzle position of the normal-ejection nozzle, a distribution ratio of large and small dots is adjusted according to the number (ratio) of large dot nozzles and small dot nozzles other than the ejection failure nozzle.

Meanwhile, at other nozzle positions that are not subjected to ejection failure compensation processing, in order to suppress density unevenness among chips, a distribution ratio of large and small dots is set to be 1:3, by giving a priority to realizing a target ejection volume. According to the present embodiment, density variation among chips is corrected at a large number of nozzle positions without an ejection failure, and also a reliable ejection failure compensation processing is performed thereby to prevent image degradation caused by an unexpected ejection failure at a small number of nozzle positions with an ejection failure. That is, also in the present embodiment, as with U.S. Pat. No. 7,249,815, density unevenness among chips is corrected, and a more reliable and less risky ejection failure compensation processing can be realized.

### Embodiment 3

In the above embodiments, a case where an ejection failure occurs in two small dot nozzles has been described, but, needless to say, presence or absence of an ejection failure nozzle and the number thereof vary depending on each chip or print head. The greater the number of ejection failure nozzles becomes, the higher a printing rate of other nozzles to perform printing on the same nozzle position as a position of the ejection failure nozzles becomes, which leads to increase of a risk caused by an unexpected ejection failure. Therefore, the present embodiment has the same configuration of that of the first embodiment, and in addition to this, performs adjustment so that the greater the number of ejection failure nozzles a chip has, the less bias a large and small dot distribution ratio becomes.

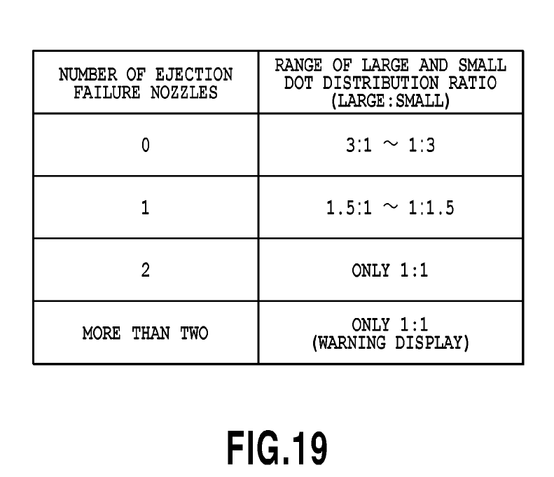

FIG. 19 is a diagram for showing the number of ejection failure nozzles in the present embodiment and ranges of large and small dot distribution ratios that can be decided by the large and small dot distribution ratio deciding unit A53 corresponding thereto.

In the case of no ejection failure nozzles, the large and small dot distribution ratio deciding unit A53 can set a large and small dot distribution ratio to be in a range of 1:3 to 3:1 for all nozzle positions. That is, the large and small dot distribution ratio deciding unit A53 sets a large and small dot distribution ratio in a range of 3:1 to 1:3 so that an average ejection volume is as close as a target ejection volume on the basis of ejection volume information of each chip acquired from the ejecting characteristic acquisition unit A51.

Meanwhile, in the case where there is one ejection failure nozzle at the same nozzle position in one chip, the large and small dot distribution ratio deciding unit A53 can set a large and small dot distribution ratio in a range of 1.5:1 to 1:1.5 for the nozzle position of the ejection failure nozzle. A case where there are a plurality of ejection failure nozzles in one chip, as long as the plurality of ejection failure nozzles are not at the same printing positions, is included in this embodiment.

In the case where, as the above embodiment, there are two ejection failure nozzles at the same nozzle position in one chip, the large and small dot distribution ratio deciding unit A53, as with the first embodiment, sets a large and small dot distribution ratio to be 1:1 for the nozzle position of the ejection failure nozzle.

Further, in the case where there are more than two ejection failure nozzles at the same nozzle position in one chip, the CPU A3 of the present embodiment informs the user that there are many ejection failure nozzles which may lead to occurrence of an image defect. Then, the large and small dot distribution ratio deciding unit A53 sets a large and small dot distribution ratio to be 1:1 for the nozzle position of the ejection failure nozzles.

In this way, according to the present embodiment, even if there is an ejection failure nozzle, an ejection volume is made to be as close as a target ejection volume by making a distribution ratio unequal as long as the inequality of a distribution ratio does not have a harmful effect on an image so much. Meanwhile, if there are many ejection failure nozzles and inequality of a distribution ratio has a significant harmful effect on an image, inequality of a distribution ratio is suppressed as much as possible, rather than approaching to a target ejection volume. Such a configuration reduces density unevenness among chips, as well as an harmful effect on an image that is caused by occurrence of an unexpected ejection failure in a balanced manner, and also allows for outputting a uniform and stable image.

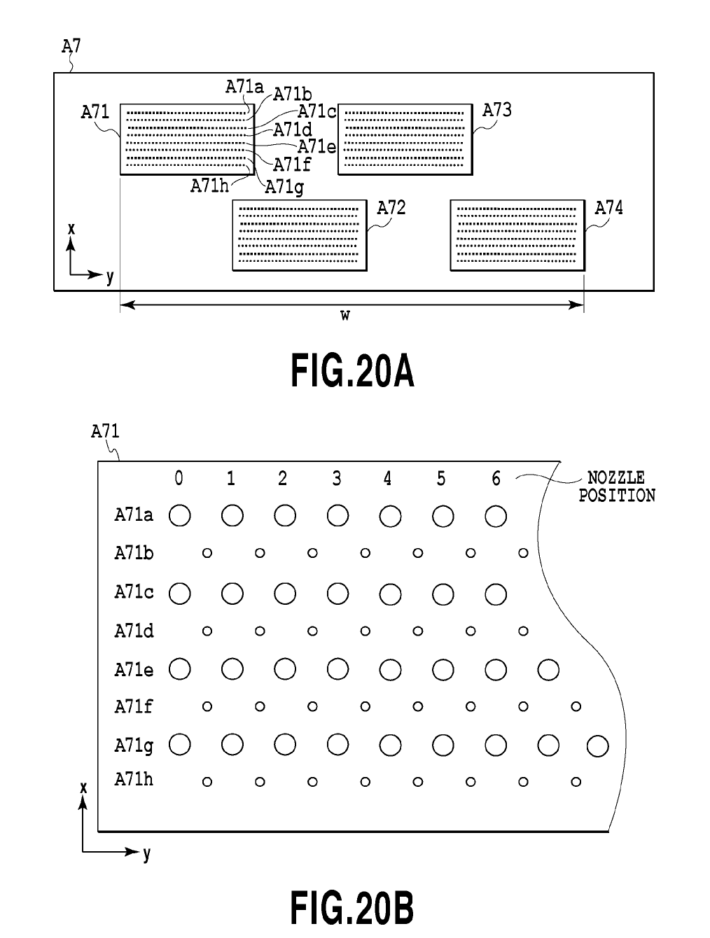

The above embodiments have been described, as an example, with respect to a print head having a configuration in which four large dot nozzles and four small dot nozzles are arranged at the same nozzle position in x direction, as illustrated in FIGS. 3A and 3B. In such a print head, even if a distribution ratio of large and small dots is changed, positions where dots are printed do not change, and therefore a change of a spatial frequency and granularity caused by change of a distribution ratio is small. However, the present invention is not limited to the print head having such a configuration. For example, a print head having a configuration in which four large dot nozzles and four small dot nozzles are shifted to each other by a half pitch in x direction as illustrated in FIGS. 20A and 20B can be used.

The number of large dot nozzle arrays and the number of small dot nozzle arrays arranged in one chip is not limited to four, either. As long as more than one large dot nozzle arrays and more than one small dot nozzle arrays are provided a distribution ratio of large and small dots can be adjusted even if there is an ejection failure nozzle, thereby obtaining an advantageous effect of the present invention.

Further, the above embodiments have been described with respect to a thermal print head as an example, but an inkjet print head in another ink ejection system such as a piezo system can be used.

Further, in the above embodiments, ejecting characteristic information that is acquired by the ejecting characteristic acquisition unit is an average ejection volume of each nozzle array, but ejecting characteristic information is not limited to an ejection volume. A density of an image rendered by each chip on a printing medium is subject to effects of not only an ink ejection volume but also a deflection due to an ejection direction or the like. A parameter such as an ejection volume and a deflection, as long as the parameter relates to variation of image density among chips, can be used as an ejecting characteristic of the above embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-101236, filed Apr. 28, 2011, which is hereby incorporated by reference herein in its entirety.

What is claimed is:

1. An inkjet printing apparatus to print an image with the use of a print head, the print head provided with a plurality of chips, each of the chips comprising: a plurality of large dot nozzle arrays composed of nozzles to print large dots on a printing medium, the nozzles being arranged in a predetermined direction, the plurality of large dot nozzle arrays being arranged in a direction intersecting with the predetermined direction; and a plurality of small dot nozzle arrays composed of nozzles to print small dots on a printing medium, the nozzles being arranged in the predetermined direction, the plurality of small dot nozzle arrays being arranged in a direction intersecting with the predetermined direction, the plurality of chips being arranged along the predetermined direction in such a way that the nozzle are arranged in series in the predetermined direction, the inkjet printing apparatus comprising:
an ejecting characteristic acquisition unit configured to acquire, for each of the chips, large dot ejecting characteristic information that indicates an ejecting characteristic of the large dot nozzle arrays, small dot ejecting characteristic information that indicates an ejecting characteristic of the small dot nozzle arrays and information about an ejection failure nozzle whose ejection state is not sufficient;
a distribution ratio deciding unit configured to decide a large and small dot distribution ratio that specifies, for each of the chips, a printing ratio of large dots and small dots so that a density of an image to be printed on a printing medium is uniform among the plurality of chips, on the basis of the large dot ejecting characteristic information and the small dot ejecting characteristic information; and
a generation unit configured to generate dot data corresponding to a plurality of normal ejection nozzles, of the plurality of large dot nozzle arrays and plurality of small dot nozzle arrays, that can print on the same position of a printing medium as a printing position of the ejection failure nozzle, on the basis of dot data of the ejection failure nozzle and the information acquired by the ejecting characteristic acquisition unit;
wherein the distribution ratio deciding unit decides the large and small dot distribution ratio so that a bias of the large and small dot distribution ratio of dot data to be printed by a plurality of nozzles that can print on the same position of a printing medium as a printing position of the ejection failure nozzle is smaller than a bias of the large and small dot distribution ratio of dot data to be printed by a plurality of nozzles that can print on a position of a printing medium other than the printing position of the ejection failure nozzle.

2. An inkjet printing apparatus according to claim 1, wherein the distribution ratio deciding unit decides the large and small dot distribution ratio of dot data to be printed by a plurality of nozzles that can print on the same position of a printing medium as a printing position of the ejection failure nozzle to be 1:1, regardless of the large dot ejecting characteristic information and the small dot ejecting characteristic information.

3. An inkjet printing apparatus according to claim 1, wherein the distribution ratio deciding unit decides the large and small dot distribution ratio of dot data to be printed by a plurality of nozzles that can print on the same position of a printing medium as a printing position of the ejection failure nozzle so that printing rates of the plurality of normal ejection nozzles are equal after the generation unit generates dot data of the normal ejection nozzle, regardless of the large dot ejecting characteristic information and the small dot ejecting characteristic information.

4. An inkjet printing apparatus according to claim 1, wherein the distribution ratio deciding unit decides the large and small dot distribution ratio in such a way that the greater the number of the ejection failure nozzles included in a plurality of nozzles that can print on the same position of a printing medium becomes, the smaller a bias of the large and small dot distribution ratio of dot data to be printed by the plurality of nozzles becomes.

5. An inkjet printing apparatus according to claim 1, further comprising a large and small dot distribution pattern generation unit configured to generate a large and small dot distribution pattern that specifies pixel positions where large dots are printed and pixel positions where small dots are printed so that large dots are arranged in a fixed spatial frequency in accordance with a large and small dot distribution ratio decided by the large and small dot distribution ratio deciding unit.

6. An inkjet printing apparatus according to claim 5, wherein the large and small dot distribution pattern generating unit provides a plurality of large and small dot distribution patterns generated in accordance with a large and small dot distribution ratio decided by the large and small dot distribution ratio deciding unit, each of the plurality of large and small dot distribution patterns corresponding to each level of gradations.

7. An inkjet printing apparatus according to claim 1, wherein the large dot ejecting characteristic information is an average ejection volume of the large dot nozzle arrays, and the small dot ejecting characteristic information is an average ejection volume of the small dot nozzle arrays.

8. An inkjet printing method to print an image with the use of a print head, the print head provided with a plurality of chips, each of the chips comprising: a plurality of large dot nozzle arrays composed of nozzles to print large dots on a printing medium, the nozzles being arranged in a predetermined direction, the plurality of large dot nozzle arrays being arranged in a direction intersecting with the predetermined direction; and a plurality of small dot nozzle arrays composed of nozzles to print small dots on a printing medium, the nozzles being arranged in the predetermined direction, the plurality of small dot nozzle arrays being arranged in a direction intersecting with the predetermined direction, the plurality of chips being arranged along the predetermined direction in such a way that the nozzle arrays are arranged in series in the predetermined direction, the method comprising:
an ejecting characteristic acquisition step to acquire, for each of the chips, large dot ejecting characteristic information that indicates an ejecting characteristic of the large dot nozzle arrays, small dot ejecting characteristic information that indicates an ejecting characteristic of the small dot nozzle arrays and information about an ejection failure nozzle whose ejection state is not sufficient;
a distribution ratio deciding step to decide a large and small dot distribution ratio that specifies, for each of the chips, a printing ratio of large dots and small dots so that a density of an image to be printed on a printing medium is uniform among the plurality of chips, on the basis of the large dot ejecting characteristic information and the small dot ejecting characteristic information; and
a generation step to generate dot data corresponding to a plurality of normal ejection nozzles, of the plurality of large dot nozzle arrays and plurality of small dot nozzle arrays, that can print on the same position of a printing medium as a printing position of the ejection failure nozzle, on the basis of dot data of the ejection failure nozzle and the information acquired by the ejecting characteristic acquisition step;
wherein the distribution ratio deciding step decides the large and small dot distribution ratio so that a bias of the large and small dot distribution ratio of dot data to be printed by a plurality of nozzles that can print on the same position of a printing medium as a printing position of the ejection failure nozzle is smaller than a bias of the large and small dot distribution ratio of dot data to be printed by a plurality of nozzles that can print on a position of a printing medium other than a printing position of the ejection failure nozzle.
